(19) United States
(12) Patent Application Publication
(10) Pub. No.: US 2025/0161804 A1
(43) Pub. Date: May 22, 2025

(54) STORAGE MEDIUM, INFORMATION PROCESSING SYSTEM, AND GAME PROCESSING METHOD

(71) Applicant: Nintendo Co., Ltd., Kyoto (JP)

(72) Inventors: Takeshi MIYAMOTO, Kyoto (JP); Shintaro JIKUMARU, Kyoto (JP)

(21) Appl. No.: 18/949,246

(22) Filed: Nov. 15, 2024

(30) Foreign Application Priority Data
Nov. 17, 2023 (JP) 2023-195647

(51) Int. Cl. A63F 13/422; A63F 13/57

(52) U.S. Cl. CPC A63F 13/422; A63F 13/57

(57) ABSTRACT

An example of an information processing system, in a race game, causes a player object to run in a first running state if there is a first operation input at a time of landing of the player object on a track path and if there is a predetermined turn operation input at a predetermined timing at or before the time of landing. The player object runs in a second running state different from the first running state if there is the first operation input at the time of landing of the player object on the track path and if there is not the turn operation input at the predetermined timing. The player object temporarily runs in a third running state that is advantageous in the race game based on a parameter that increases in accordance with continuation of the second running state.

### CROSS REFERENCE TO RELATED APPLICATION

This application claims priority to Japanese Patent Application No. 2023-195647, filed on Nov. 17, 2023, the entire contents of which are incorporated herein by reference.

### FIELD

The present disclosure relates to a storage medium, an information processing system, and a game processing method for playing a race game.

### BACKGROUND AND SUMMARY

The game process of conventional race games controls a car object in a race to run in a drift state when turning a corner. By enabling the car object to drift, it is possible to improve the playability of player operations when the car object turns a corner.

In the game process described above, the car object drifts basically only when turning a corner, and the player operation tends to be monotonous when the car object is running straight, leaving room for improvement.

In view of this, the present application discloses a storage medium, an information processing system, and a game processing method that can improve the playability of operations when the object is running straight in a race game.

(1)

An example of one or more non-transitory computer-readable media stores therein instructions that, when executed, cause one or more processors to execute race game operations. The race game operations comprises: controlling a player object in a virtual space in accordance with a user operation; causing the player object to run in a first running state if there is a first operation input at a time of landing of the player object on a track path and if there is a predetermined turn operation input at a predetermined timing at or before the time of landing; causing the player object to run in a second running state different from the first running state if there is the first operation input at the time of landing of the player object on the track path and if there is not the turn operation input at the predetermined timing; and causing the player object to temporarily run in a third running state that is advantageous in a race game based on a parameter that increases in accordance with continuation of the second running state.

With configuration (1) above, the player can, by the first operation input, set the player object to the advantageous third running state when the player object is running straight in the race game. Thus, it is possible to motivate the player to perform operations even when the player object is running straight, thereby improving the playability of operations when the player object is running straight.

(2)

In configuration (1) above, a speed of the player object in the third running state may be faster than a speed of the player object in a normal running state.

With configuration (2) above, the player will perform game operations while considering the timing to set the player object to the third running state, thereby improving the strategic aspect of the race game.

(3)

In configuration (1) or (2) above, the second running state may be a running state that is disadvantageous in the race game.

With configuration (3) above, the player is challenged to decide whether or not to set the player object in the disadvantageous first running state in order to set the player object in the advantageous third running state, thereby generating a strategic aspect in the race game.

(4)

In configuration (3) above, a speed of the player object in the second running state may be slower than a speed of the player object in a normal running state.

With configuration (4) above, it is made difficult for the player object to run fast in the second running state, which leads to the advantageous third running state, thereby generating a strategic aspect in the race game.

(5)

In configuration (4) above, a cornering performance of the player object in the second running state may be lower than the cornering performance of the player object in the first running state.

With configuration (5) above, the cornering performance of the player object is lowered in the second running state, which leads to the advantageous third running state, thereby generating a strategic aspect in the race game.

(6)

In configuration (5) above, the cornering performance of the player object in the second running state may be lower than the cornering performance of the player object in the normal running state.

With configuration (6) above, the disadvantage in the second running state is emphasized more than in configuration (5) above, thereby further improving the strategic aspect and improve the playability of the race game.

(7)

In any one of configurations (1) to (6) above, causing the player object to temporarily run in the third running state may be executed based on the parameter reaching a predetermined value.

With configuration (7) above, the player is required to perform operations so that the second running state continues for a certain period of time in order to achieve the third running state, thereby further improving the strategic aspect of the race game.

(8)

In any one of configurations (1) to (7) above, the race game operations may further comprise: causing the player object to perform a first jump action in response to the first operation input being made while the player object is running on the track path.

With configuration (8) above, it is possible to notify the player in an easily understood manner that the first operation input has been accepted.

(9)

In any one of configurations (1) to (8) above, causing the player object to run in the second running state may be executed if the speed of the player object running on the track path in a normal running state exceeds a first speed while the first operation input is continuing.

With configuration (9) above, the player can set the player object to the second running state not only when the player object lands but also when running. Then, it is possible to increase the chance for the player object to transition to the second running state.

(10)

In any one of configurations (1) to (9) above, causing the player object to run in the second running state may be executed if there is the first operation input at the time of landing of the player object on the track path, if there is not the turn operation input at the predetermined timing, and if the speed at the time of landing has exceeded a second speed.

With configuration (10) above, it is possible to inhibit the player object that is stopped or running at a low speed from going through the second running state to the advantageous third running state.

(11)

In any one of configurations (1) to (10) above, causing the player object to run in the second running state may be executed while the first operation input is continuing since the first operation input was made. Causing the player object to run in the third running state may be executed in response to ending of the continuing first operation input after the parameter reaches the predetermined value.

With configuration (11) above, it is easier for the player to operate the player object to run in the second running state and to operate the player object to run in the third running state, thereby improving the operability of the player object.

(12)

In configuration (11) above, the race game operations may further comprise: causing the player object to perform a first jump action in response to the first operation input being made while the player object is running; and causing the player object running in the second running state to perform a second jump action in response to ending of the continuing first operation input after the parameter reaches the predetermined value.

With configuration (12) above, the player can easily recognize that the first operation input has been accepted and that the end of the first operation input has been accepted.

(13)

In configuration (12) above, causing the player object to run in the third running state may be executed after the player object lands from the second jump action.

With configuration (13) above, it is possible to challenge the player to consider the position from which to jump such that the player object can land at an appropriate position by the second jump action, thereby improving the strategic aspect of the race game.

(14)

In configuration (12) or (13) above, the second jump action may be executed based on the turn operation input made upon ending of the continuing first operation input.

With configuration (14) above, variations are provided for the second jump action, thereby improving the playability of the game.

(15)

In configuration (14) above, the second jump action may be executed based on the turn operation input made upon ending of the continuing first operation input. An amount of movement by the second jump action may be greater than an amount of movement by the first jump action.

With configuration (15) above, it is easier for the player to adjust the position at which the player object runs in the second running state after landing from the second jump action, thereby improving the operability of the game operation.

(16)

In any one of configurations (12) to (15) above, the race game operations may further comprise: causing the player object to run in a fourth running state, in which the player object is caused to run on the wall surface, in response to the player object coming in proximity to a wall surface while in the second jump action.

With configuration (16) above, it is possible to give the player a choice of whether or not to cause the player object run on the wall surface by the second jump action, thereby improving the strategic aspect of the race game.

(17)

In any one of configurations (1) to (16) above, the race game operations may further comprise: causing the player object to temporarily run in a fifth running state that is advantageous in the race game based on a parameter that increases in accordance with continuation of the first running state.

With configuration (17) above, even when the player object runs in the first running state, it is possible to have the player object run in an advantageous running state, thereby further improving the strategic aspect of the race game.

(18)

In configuration (17) above, a speed of the player object in the fifth running state may be faster than the speed of the player object in a normal running state.

With configuration (18) above, the player can have the player object run faster on the course by setting the player object to the fifth running state.

(19)

In any one of configurations (1) to (18) above, the race game operations may further comprise: displaying the player object on a display device in different manners of display in the first running state and in the second running state.

With configuration (19) above, it is possible to allow the player to recognize the running state of the player object in an easy-to-understand manner.

(20)

In any one of configurations (1) to (19) above, a plurality of circuit courses and connecting courses that connect between the circuit courses may be arranged in the virtual space. In the race game, the player object may run in two or more of the circuit courses and a connecting course that connects together the two or more circuit courses.

With configuration (20) above, it is possible to include, in a single race, both a situation in which running in the first running state is likely to be advantageous and a situation in which running in the second running state is likely to be advantageous, thereby improving the playability of the race game.

It should be noted that the present specification discloses an example of an information processing device and an information processing system that execute processes described in (1) to (20) above. The present specification also discloses an example of a game processing method that executes processes described in (1) to (20) above.

According to the storage medium, the information processing system, and the game processing method set forth above, it is possible to improve the playability of operations when the object is running straight in the race game.

These and other objects, features, aspects, and effects will become more apparent from the following detailed description in conjunction with the accompanying drawings.

### BRIEF DESCRIPTION OF THE DRAWINGS

FIG. 1 is a diagram showing an example of the state where a non-limiting left controller and a non-limiting right controller are attached to a non-limiting main body apparatus;

FIG. 2 is a diagram showing an example of the state where each of the non-limiting left controller and the non-limiting right controller is detached from the non-limiting main body apparatus;

FIG. 3 is six orthogonal views showing an example of the non-limiting main body apparatus;

FIG. 4 is six orthogonal views showing an example of the non-limiting left controller;

FIG. 5 is six orthogonal views showing an example of the non-limiting right controller;

FIG. 6 is a block diagram showing an example of the internal configuration of the non-limiting main body apparatus;

FIG. 7 is a block diagram showing examples of the internal configurations of the non-limiting main body apparatus, the non-limiting left controller, and the non-limiting right controller;

FIG. 8 is a diagram showing an example of transitions over time of the running state of the player object when a drift run is performed;

FIG. 9 is a diagram showing an example of a game image when the player object is performing a drift run;

FIG. 10 is a diagram showing an example driving path of the player object when turning in the normal state and when turning in the drift state;

FIG. 11 is a diagram showing an example of a game image when the player object in the turbo-enabled state is performing a drift run;

FIG. 12 is a diagram showing an example of a game image while the player object is performing a turbo run;

FIG. 13 is a diagram showing an example of transitions over time of the running state of the player object when a power-charge run is performed;

FIG. 14 is a diagram showing another example of transitions over time of the running state of the player object when a power-charge run is performed;

FIG. 15 is a diagram showing an example of a game image when the player object is performing a power-charge run;

FIG. 16 is a diagram showing an example of a game image when the player object having entered the turbo-enabled state is performing a power-charge run;

FIG. 17 is a diagram showing an example of a game image when the player object is performing a special jump;

FIG. 18 is a diagram showing an example of transitions over time of the running state of the player object when a wall run is performed;

FIG. 19 is a diagram showing an example of a game image when the player object is performing a special jump;

FIG. 20 is a diagram showing an example of a game image when the player object is performing a wall run;

FIG. 21 is a diagram showing an example of transitions over time of the running state of the player object when a rail run is performed;

FIG. 22 is a diagram showing an example of a game image before the player object starts a rail run;

FIG. 23 is a diagram showing an example of a game image when the player object is performing a rail run;

FIG. 24 is a diagram showing an example of the player object performing consecutive special jumps;

FIG. 25 is a diagram showing an example of how an attack item moves when an attack item is launched on a rail object;

FIG. 26 is a diagram showing an example of a course that is set in the virtual space in the race game of an exemplary embodiment;

FIG. 27 is a diagram showing an example of various data used in information processes in a non-limiting game system;

FIG. 28 is a flowchart showing an example of a flow of the game process executed by the non-limiting game system;

FIG. 29 is a sub-flowchart showing an example of a detailed flow of the normal run process of step S3 shown in FIG. 28;

FIG. 30 is a sub-flowchart showing an example of a detailed flow of the normal run process of step S3 shown in FIG. 28;

FIG. 31 is a sub-flowchart showing an example of a detailed flow of the drift run process of step S5 shown in FIG. 28;

FIG. 32 is a sub-flowchart showing an example of a detailed flow of the power-charge run process of step S7 shown in FIG. 28;

FIG. 33 is a sub-flowchart showing an example of a detailed flow of the special jump process of step S9 shown in FIG. 28;

FIG. 34 is a sub-flowchart showing an example of a detailed flow of the wall run process of step S10 shown in FIG. 28;

FIG. 35 is a sub-flowchart showing an example of a detailed flow of the rail run process of step S13 shown in FIG. 28; and

FIG. 36 is a sub-flowchart showing an example of a detailed flow of the item control process of step S15 shown in FIG. 28.

### DETAILED DESCRIPTION OF NON-LIMITING EXAMPLE EMBODIMENTS

### [1. Configuration of Game System]

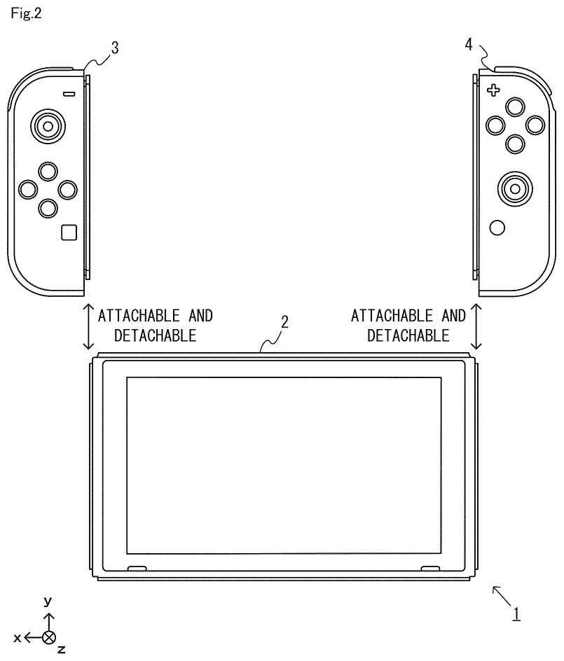

A game system according to an example of an exemplary embodiment is described below. An example of a game system 1 according to an exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to an exemplary embodiment is described, and then, the control of the game system 1 according to an exemplary embodiment is described.

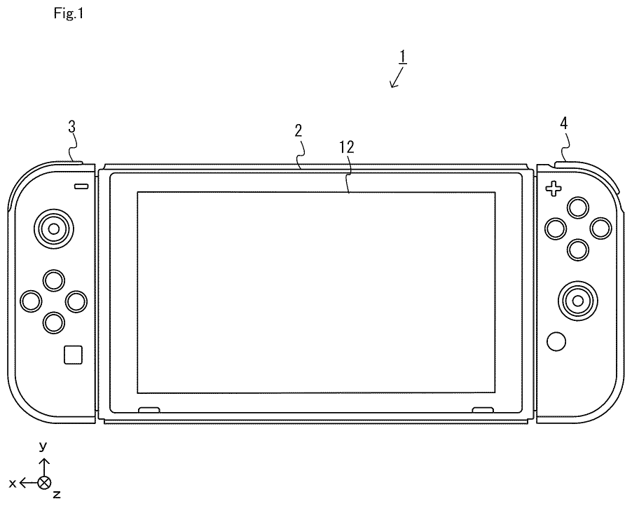

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

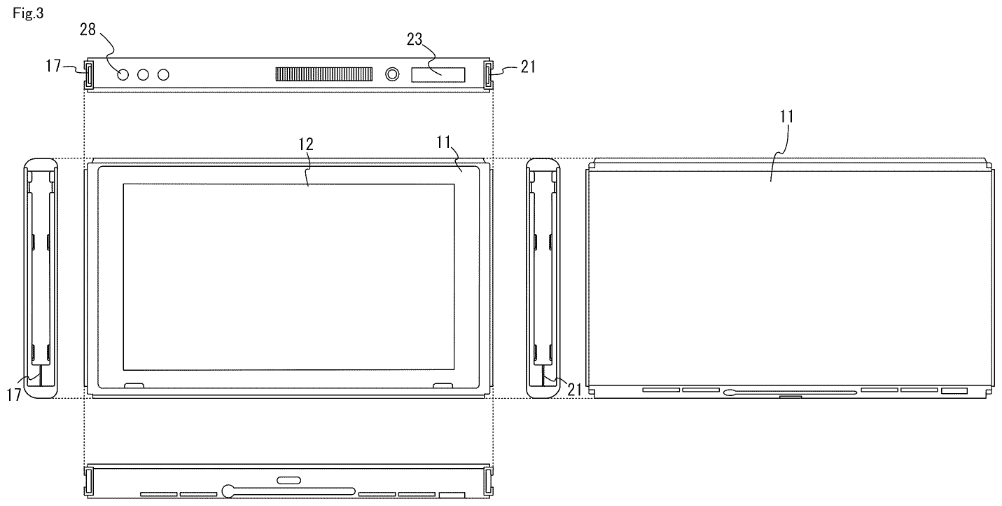

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

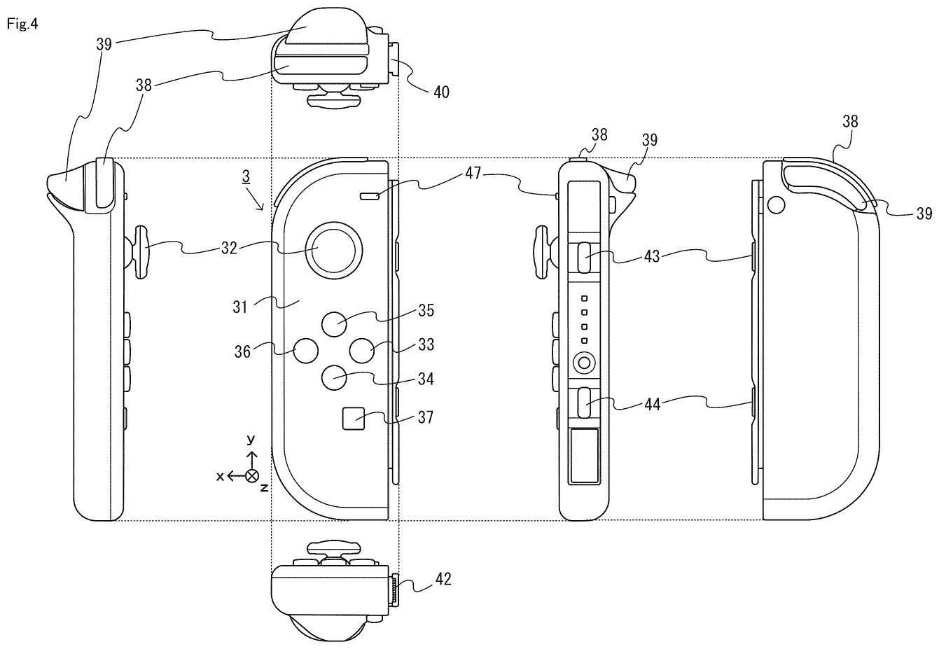

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction (i.e., a y-axis direction shown in FIGS. 1 and 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

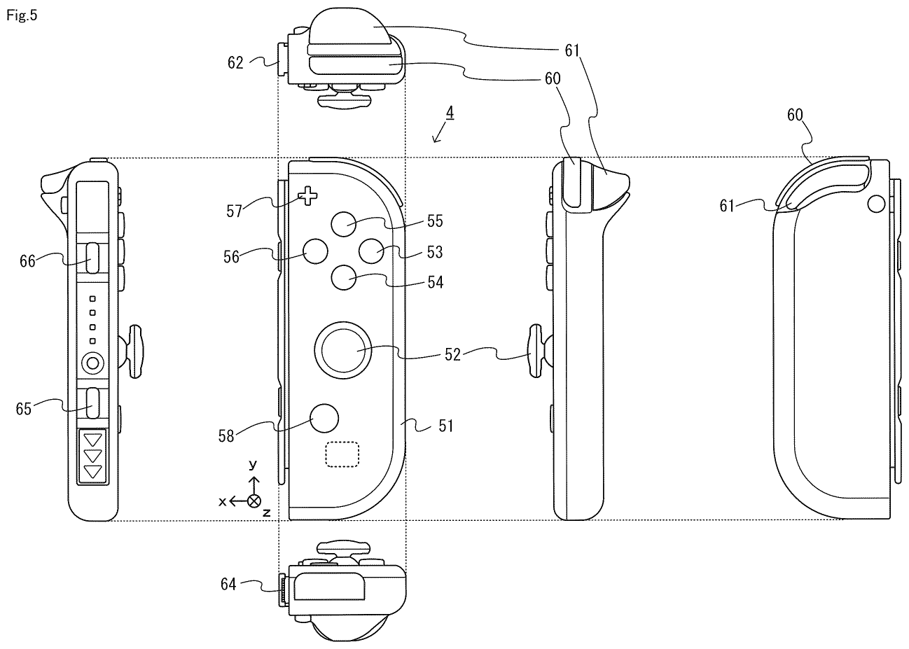

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

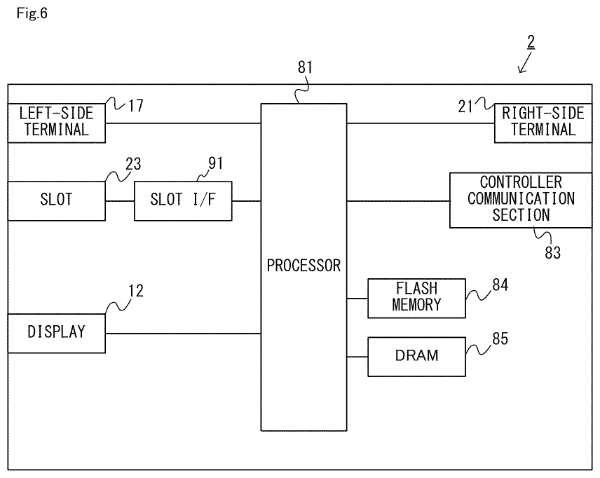

FIG. 6 is a block diagram showing an example of the internal configuration of the main body apparatus 2. The main body apparatus 2 includes components 81, 83 to 85, and 91 shown in FIG. 6 in addition to the components shown in FIG. 3. Some of the components 81, 83 to 85, and 91 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, and the right terminal 21. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. As described above, in the exemplary embodiment, the main body apparatus 2 can perform both wired communication and wireless communication with each of the left controller 3 and the right controller 4.

Further, the display 12 is connected to the processor 81. The processor 81 displays a generated image (e.g., an image generated by executing the above information processing) and/or an externally acquired image on the display 12.

It should be noted that although not shown in the figures, the main body apparatus 2 includes a network communication section. The network communication section is connected to a processor. The network communication section communicates (e.g., wirelessly) with external devices via a network. In the exemplary embodiment, as the first communication mode, the network communication section communicates with external devices through connection with a wireless LAN using a method compliant with the Wi-Fi standard. As the second communication mode, the network communication section communicates wirelessly with other main body apparatuses of the same type using a predetermined communication method (e.g., communication using a proprietary protocol or infrared communication).

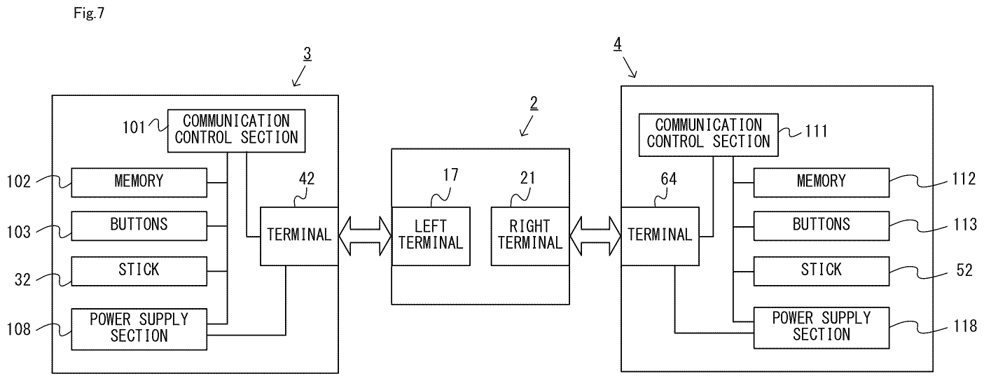

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103, and, the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and, the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Overview of Processes in Game System]

The following is an overview of information processing to be executed in the game system 1. In the exemplary embodiment, the game system 1 executes a race game in which a player object operated by a player (i.e., the user of the game system 1) races in a virtual space. In a race game, for example, the player object runs on a course provided in the virtual space to compete with other objects participating in the race for position or time required to reach the goal. It should be noted that the specifics of the race game are arbitrary and are not limited to the above. In addition to the game mode in which the player objects compete for position or time, the race game may also include a game mode in which the player objects run freely in the virtual space without competing for position or time (e.g., the game in the second mode to be described below).

In the exemplary embodiment, the player operates, as a mobile object to race, a car object which the player character rides. That is, the player object in the exemplary embodiment is a mobile object consisting of a player character and a car object. In the race game, multiple player characters and multiple car objects with different appearances and abilities are provided, and the player may be allowed to freely select any combination of a player character and a car object. It should be noted that in other embodiments, the object which the player character rides may be any object, not limited to a car object, and may be an object such as a motorcycle, an airplane, or an animal. The player object may be only the player character or only a vehicle such as a car object.

In the exemplary embodiment, as operations on the player object, the player can perform at least an acceleration operation, a brake operation, a directional operation, an action operation, and an item operation. The acceleration operation is an operation of accelerating the player object, and in the exemplary embodiment, the acceleration operation is performed by an operation input of pressing the A-button 53 of the right controller 4. The brake operation is an operation of decelerating the player object, and in the exemplary embodiment, the brake operation is performed by an operation input of pressing the B-button 54 of the right controller 4. The direction operation is an operation of changing the moving direction of the player object, and in the exemplary embodiment, the direction operation is performed by an operation input on the analog stick 32 of the left controller 3. Specifically, in accordance with an operation input of tilting the analog stick 32 left and right, the player object is controlled to change the moving direction in the direction corresponding to the direction in which the analog stick 32 is tilted and by the amount of turn corresponding to the amount of tilt. The action operation is an operation of causing the player object to perform an action such as a jump action or transition to the power-charge state or the drift state to be described below, and in the exemplary embodiment, the action operation is performed by an operation input of pressing the first R-button 60 of the right controller 4. As will be explained in detail later, in the exemplary embodiment, the player object performs a normal jump operation or a special jump operation depending on an action operation input. The item operation is an operation of causing the player object to use an item, and in the exemplary embodiment, the item operation is performed by an operation input of pressing a first L-button 38 of the left controller 3. It should be noted that in the exemplary embodiment, the player object can obtain items during the race game, and the player object performs an action of using an obtained item in response to an item operation input.

In the exemplary embodiment, the player object can take four running states during the race game, i.e., the normal state, the drift state, the power-charge state, and the object run state. These running states will be described below. It should be noted that in other embodiments, the player object does not have to be able to take the four running states, but may take at least one of the four states. For example, the player object may take three states, i.e., the normal state, the drift state, and the power-charge state, or the player object may take two states, i.e., the normal state and the object run state.

The normal state is the normal running state, which is none of the drift state, the power-charge state, and the object run state. In the normal state, the action of the player object is controlled according to operation inputs of the acceleration operation, the brake operation, the directional operation, the action operation, and the item operation. During the race game, when the player object is operated by these operation inputs, the running state of the player object transitions to the drift state, the power-charge state, or the object run state.

### [2-1. Drift State]

The drift state is a running state in which the player object slides sideways while turning a corner. As will be explained in detail later, in the exemplary embodiment, by running in the drift state (called a “drift run”), the car object can turn a corner more sharply than in the normal state. The details of the drift state will be described below.

In the exemplary embodiment, the player object may be mid-air by jumping as a result of running over a bump in the race course, by falling from a high location in the race course, as well as by a jump action. If a predetermined drift condition is satisfied at the time of landing on the race course from the air, the player object enters the drift state.

Here, in the exemplary embodiment, the drift condition is that the following first to third conditions are satisfied.
First condition: the acceleration operation input and the action operation input are being made at the time of landing.
Second condition: the speed of the player object is higher than a predetermined transition speed.
Third condition: the directional operation input is made within a decision period, which is determined based on the time of landing.

It should be noted that the content of the drift condition is arbitrary, and in other embodiments, the drift condition may not have to include any of the first to third conditions above, or may include conditions different from the first to third conditions.

Regarding the first condition, the acceleration operation input and the action operation input need only be being made at the time of landing, and the timing at which these operation inputs are started is arbitrary. For example, the first condition is satisfied even if these operation inputs are started at any timing during the period in which the player object is mid-air. These operation inputs may be started before the player object is mid-air. In the exemplary embodiment, if an action operation input is started while the player object is running in the race course, the player object performs a normal jump action under a certain condition. If the action operation input is continued during this normal jump, and if the action operation input is still being made at the time of landing from the normal jump, the first condition is satisfied (as long as the acceleration operation input is being made at the time of landing). It should be noted that the first condition is satisfied even if the action operation input for a normal jump is ended during a normal jump and a new action operation input is made at the time of landing from a normal jump (as long as the acceleration operation input is being made at the time of landing).

Regarding the second condition, the transition speed is set to a speed slower than the maximum speed of the player object in the normal state. It should be noted that the maximum speed is, for example, the highest speed that the player object can reach when the acceleration operation input is made continuously. For example, at the start of a race, or in a situation where the player object has spun or otherwise stopped, the speed of the player object is zero, so the second condition is not satisfied. As will be explained in detail later, after the drift state, the player object can transition under a certain condition to the turbo state, where the player object can run at a high speed. The second condition prevents the player object from suddenly entering the drift state and running in the turbo state in a situation where the player object is running at a low speed (or stopped).

Regarding the third condition, the decision period is a period of time from a predetermined period before the time of landing to the time of landing. The length of the predetermined period is arbitrary. For example, in the exemplary embodiment, the length of the decision period above is set to be equal to or greater than the length of the period in which the player object performs a normal jump (the length of the period in which the player object is mid-air when the player object performs a normal jump off a level ground). Thus, the player can satisfy the third condition by making a directional operation input at any timing while the player object is performing a normal jump. It should be noted that it is not necessary that a directional operation input is made during the entire decision period for the third condition to be satisfied, and the third condition is satisfied if a directional operation input is made at any point in time during the decision period.

The game system 1 may determine that a directional operation input for satisfying the third condition is not being made when the tilt angle of the analog stick 32 during the decision period is less than or equal to a predetermined value.

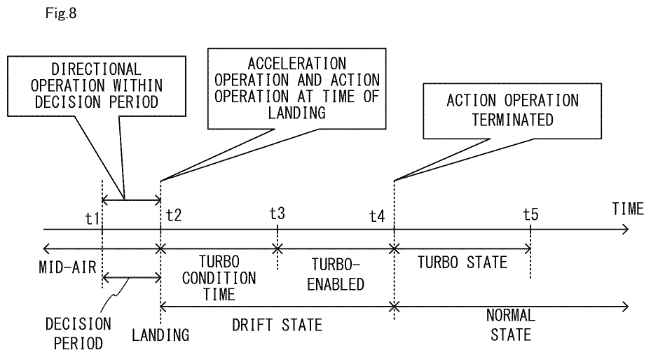

FIG. 8 is a diagram showing an example of transitions over time of the running state of the player object when a drift run is performed. In the example shown in FIG. 8, the player object is assumed to have landed at time t2 from a state where the player object is mid-air. It is also assumed that the acceleration operation input and the action operation input are being made at time t2. It is further assumed that the speed of the player object at the time of landing is faster than the transition speed. Furthermore, it is assumed that the directional operation input is made during the decision period from time t1 to time t2. Thus, in the example shown in FIG. 8, since the first to third conditions of the drift condition are satisfied at time t2, the game system 1 determines that the drift condition is satisfied and sets the player object to the drift state after landing.

In the exemplary embodiment, the drift state of the player object is sustained as long as the action operation input that was being performed at the time of landing is continued. That is, the player object is in the drift state while the first R-button 60 is pressed, which was being pressed at the time of landing, and the drift state is canceled in response to discontinuation of pressing of the first R-button 60. It should be noted that in the exemplary embodiment, the drift state is not canceled even when the directional operation input is discontinued during the drift state of the player object. In the exemplary embodiment, the drift state of the player object is ended when the acceleration operation input ends, as well as when the action operation input ends. It should be noted that in other embodiments, the game system 1 may allow the drift state to continue even if the acceleration operation input is discontinued during the drift state of the player object.

It should be noted that in other embodiments, the operation to cancel the drift state may be arbitrary and is not limited to the operation described above. For example, in other embodiments, the drift state may be continued even after discontinuation of pressing of the first R-button 60 corresponding to the action operation input, in which case the drift state may be canceled when the first R-button 60 is pressed again. For example, the drift state may be canceled by a different operation input than the action operation input, e.g., in response to discontinuation of the directional operation input during the drift state, or in response to pressing of another button different from the first R-button 60.

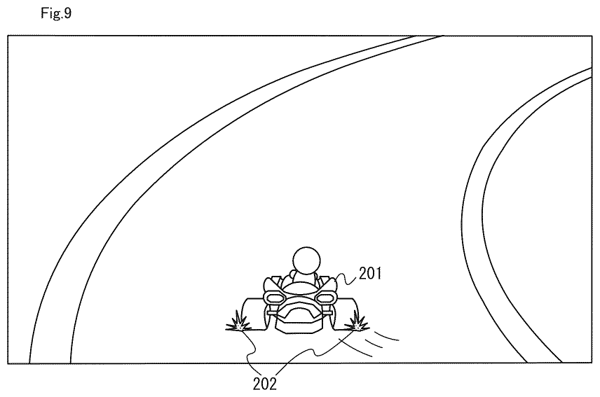

FIG. 9 is a diagram showing an example of a game image when the player object is performing a drift run. In the exemplary embodiment, the appearance of the player object 201 in the drift state is different from the appearance of the player object 201 in the normal state. Specifically, the game system 1 displays the player object 201 in the drift state in a manner of display with a special effect image 202 representing sparks at the rear wheels (see FIG. 9). It should be noted that the player object in the normal state is not displayed with the spark special effect image 202. This allows the player to recognize that the player object is in the drift state. It should be noted that the method of varying the manner of display depending on whether or not the player object is in the drift state is arbitrary, and in other embodiments, the game system 1 may, for example, display a special effect image representing a cloud of dust instead of (or in addition to) a special effect image representing sparks.

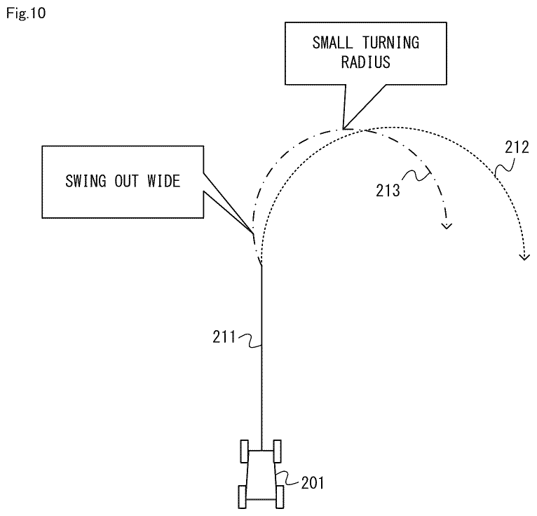

In the exemplary embodiment, the behavior of the player object in response to an operation input by the player varies between the drift state and the normal state. That is, the game system 1 varies the method of controlling the player object between the drift state and the normal state. FIG. 10 shows an example driving path of the player object when turning in the normal state and that when turning in the drift state. In FIG. 10, a driving path 211 when the player object is running straight before turning a corner is indicated by a solid line, a driving path 212 when the player object is turning a corner in the normal state is indicated by a dotted line, and a driving path 213 when the player object is turning a corner in the drift state is indicated by a one-dot-chain line. It should be noted that in the example shown in FIG. 10, the driving path 212 and the driving path 213 are both a driving path to be taken when the player performs the same directional operation input (for example, an operation input of tilting the analog stick 32 farthest to the right).

As shown in FIG. 10, in the drift state, as compared with the normal state, the player object is controlled to change its direction so as to swing out wide in the direction opposite to the direction of the turn (i.e., the direction indicated by the directional operation input) in the beginning of the turn and then turn with a smaller turning radius. That is, the minimum turning radius of the player object in the drift state is smaller than that in the normal state. Thus, when turning in the drift state, although the player object swings out wide compared to when turning in the normal state in the beginning of the turn, the player object can thereafter turn more sharply than in the normal state (see FIG. 10). Thus, the drift state is a state in which the player object is controlled so as to run with a better cornering performance than in the normal state. It should be noted that in the exemplary embodiment, in the drift state, the player object is controlled to turn by a predetermined turning amount when there is no directional operation input. The predetermined turning amount is arbitrary and may, for example, be predetermined or may be determined to be the turning amount at the start of the drift state.

As described above, it can be said that the drift state is a state in which it is possible to turn a corner more advantageously than in the normal state, depending on the situation. It should be noted that the method of controlling the player object in the drift state is arbitrary and is not limited to the above. For example, in other embodiments, the game system 1 may control the player object in the drift state so as to turn with a smaller turning radius than in the normal state without swinging out wide in the beginning of the turn. The drift state may have a disadvantage compared to the normal state (e.g., in the exemplary embodiment, the disadvantage of a larger turning radius than in the normal state in the beginning of the turn).

As shown in FIG. 8, in the exemplary embodiment, when the player object is in the drift state, if the drift state is continued longer than a predetermined turbo condition time, the player object enters the turbo-enabled state. In the example shown in FIG. 8, the player object enters the turbo-enabled state at time t3, which is after the turbo condition time has elapsed since the player object entered the drift state at time t2. Specifically, the game system 1 counts the amount of time over which the drift state has continued, as a drift parameter, which indicates the degree of continuation of the drift state, and transitions the player object to the turbo-enabled state in response to this amount of time reaching the turbo condition time. It should be noted that the drift parameter may be any parameter whose value increases in accordance with the continuation of the drift state of the player object. For example, in other embodiments, the drift parameter may be a parameter that indicates the distance traveled by the player object since the player object entered the drift state. The amount of time until entering the turbo-enabled state may be shortened based on operations during the drift state. For example, the amount of time until entering the turbo-enabled state may be shortened by quickly switching the directional operation input left and right during the drift state.

The turbo-enabled state is a state where a turbo run (explained in detail later) is available. In the exemplary embodiment, the turbo-enabled state is a state that is set independently of the four running states described above (i.e., the normal state, the drift state, the power-charge state, and the object run state). For example, in the exemplary embodiment, the player object may enter the turbo-enabled state during the drift state, and the player object may also enter the turbo-enabled state during the power-charge state.

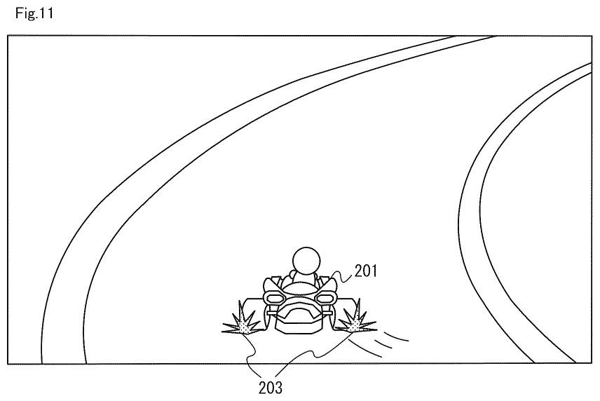

FIG. 11 is a diagram showing an example of a game image when the player object performing a drift run is in the turbo-enabled state. In the exemplary embodiment, the game system 1 displays the player object 201 in the turbo-enabled state in a different manner of display than when not in the turbo-enabled state. For example, in the exemplary embodiment, the game system 1 displays the player object 201 in the turbo-enabled state in a manner of display with a special effect image 203 representing sparks at the rear wheels (see FIG. 11). It should be noted that the special effect image 203 is larger than the special effect image 202 (see FIG. 9), which is displayed attached to the player object 201 in the drift state, which is not the turbo-enabled state. The special effect image 203 is displayed in place of the special effect image 202. This allows the player to recognize that the player object in the drift state is in the turbo-enabled state. It should be noted that the method of varying the manner of display depending on whether or not the player object is in the turbo-enabled state is arbitrary, and in other embodiments, the game system 1 may display the special effect image 202 and the special effect image 203 in different colors, for example.

As shown in FIG. 8, when the drift state is canceled (i.e., the action operation input performed to start the drift state is ended) at the point in time (time t4) when the player object is in the turbo-enabled state, the player object returns to the normal state and enters the turbo state in which the player object performs a turbo run. It should be noted that the turbo state, like the turbo-enabled state, is a state that is set independently of the four running states described above (i.e., the normal state, the drift state, the power-charge state, and the object run state). In the exemplary embodiment, the player object may enter the turbo state while in the normal state as well as while in other states.

It should be noted that although not shown in the figures, if the drift state is canceled before the player object enters the turbo-enabled state while in a drift run (before time t3 in the example shown in FIG. 8), the player object returns to the normal state without entering the turbo state.

Also, in the exemplary embodiment, when the drift state ends in response to discontinuation of the acceleration operation input during the drift state, the player object enters the normal state without entering the turbo state.

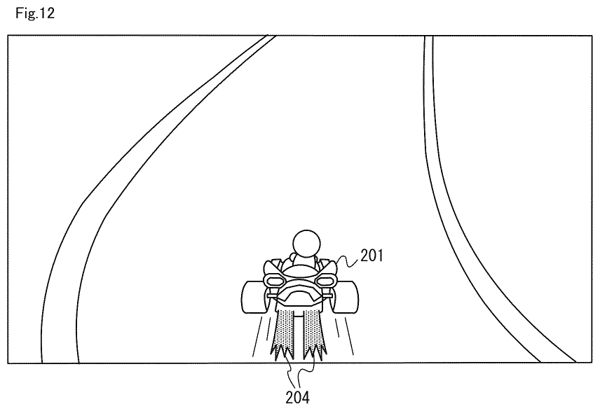

FIG. 12 is a diagram showing an example of a game image while the player object is performing a turbo run. In the exemplary embodiment, the game system 1 displays the player object 201 in the turbo state in a different manner than when the player object 201 is not in the turbo state. For example, in the exemplary embodiment, the game system 1 displays the player object 201 in the turbo state in a manner of display with a special effect image 204 representing fire blowing backward (see FIG. 12). This allows the player to recognize that the player object is in the turbo state. It should be noted that the method of varying the manner of display depending on whether or not the player object is in the turbo state is arbitrary, and in other embodiments, the game system 1 may, for example, display a special effect image representing a cloud of dust instead of (or in addition to) the special effect image 204 representing fire.

In the exemplary embodiment, the turbo state is a state in which the player object can run at a higher speed than when the player object is not in the turbo state. In the exemplary embodiment, when the player object is in the turbo state, the game system 1 accelerates the player object until it reaches a predetermined turbo speed, and after the player object reaches the turbo speed, the speed of the player object is maintained at the turbo speed. It should be noted that the turbo speed is set to be faster than the maximum speed of the player object when the player object is not in the turbo state. It should be noted that the maximum speed is, for example, the highest speed that the player object can reach when the acceleration operation input is made continuously. It should be noted that in the race game, there may be an item that allows the player object to temporarily run at high speed by using the item, or an area in the virtual space where the player object can temporarily run at high speed by passing through the area. In this case, the turbo speed may be faster, the same, or slower than the speed at which the player object travels at high speed by the item or the area described above. The speed control for the player object while in the turbo state is not limited to the above. For example, in other embodiments, the game system 1 may control the player object to gradually decelerate without maintaining the turbo speed after reaching the turbo speed, or may control the player object to accelerate for a predetermined period at a predetermined acceleration.

It should be noted that in the exemplary embodiment, the player object may enter the drift state when the drift condition is satisfied at the time of landing while in a turbo run. In this case, the player object is controlled by the control method in the drift state described above for the moving direction, and controlled by the control method in the turbo state for the speed. That is, in the case described above, the player object can turn a corner as in the drift state but at a higher speed than in the drift state while not in the turbo state. It should be noted that in other embodiments, the player object may be controlled not to perform a turbo run when the player object enters the drift state while in a turbo run.

As described above, in the exemplary embodiment, the game system 1 causes the player object to temporarily run in the turbo state, which is advantageous in the race game, based on the drift parameter, which increases as the drift state continues, reaching a predetermined value. Therefore, in the race game, the player will perform game operations while considering whether or not to have the player object run in the drift state, thereby improving the strategic aspect of the race game. For example, even if the normal state is more advantageous than the drift state when the player only needs to run through a corner, the player needs to consider whether to choose the normal state or the drift state after comprehensively taking into account that the player object can enter the turbo state after the drift state.

As shown in FIG. 8, the turbo state of the player object ends when the predetermined turbo limit time has elapsed (time t5 in FIG. 8) since the start of the turbo state. When the turbo state ends, the player object is running in the normal state, which is not the turbo state.

In the exemplary embodiment, the turbo-enabled state is divided into three stages, from the first stage to the third stage. Specifically, until a predetermined first time elapses since the player object enters the turbo-enabled state, the player object is in the first stage of the turbo-enabled state; after the first time elapses until a predetermined second time elapses, the player object is in the second stage of the turbo-enabled state; and after the second time has elapsed, the player object is in the third stage of the turbo-enabled state.

In the exemplary embodiment, the length of the turbo limit time (the amount of time from time t4 to time t5 in the example shown in FIG. 8) during which the player object maintains the turbo state is set according to the stage of the turbo-enabled state before entering the turbo state. Specifically, when the turbo-enabled state is in the first stage, the length of the turbo limit time is set to the first duration, when the turbo-enabled state is in the second stage, the length of the turbo limit time is set to the second duration longer than the first duration, and when the turbo-enabled state is in the third stage, the length of the turbo limit time is set to the third duration, which is longer than the second duration. That is, the longer the turbo-enabled state is sustained before transitioning to the turbo state, the longer the player object can sustain the turbo state. It should be noted that in other embodiments, the number of stages of the turbo-enabled state is arbitrary and may be one or two stages, or four or more stages. In other embodiments, the gaming system 1 may allow the turbo state to be sustained for an amount of time proportional to the amount of time over which the turbo-enabled state is maintained.

It should be noted that in the exemplary embodiment, the special effect image 203 indicating that the player object is in the turbo-enabled state varies depending on the stage of the turbo-enabled state. For example, the special effect image 203 is displayed in different colors depending on the stage of the turbo-enabled state. This allows the player to recognize the current stage of the turbo-enabled state. It should be noted that the method of varying the manner of display depending on the stage of the turbo-enabled state is arbitrary, and in other embodiments, the game system 1 may vary the size of the special effect image 203 depending on the stage.

As described above, in the exemplary embodiment, the player can cause the player object to drift. By performing a drift run, the player object can advantageously turn a corner and can also run at high speed by a turbo run following the drift run. Therefore, by causing the player object to perform a turbo run at an appropriate timing during the race game, the player object can run advantageously in the race game.

It should be noted that in other embodiments, the condition for transitioning the player object to the drift state is arbitrary. For example, in other embodiments, in addition to (or instead of) determining the drift condition at the time of landing of the player object, the game system 1 may transition the player object to the drift state on the condition that a directional operation input be made continuously for a certain period of time while the player object is running. The game system 1 may also transition the player object to the drift state by a plurality of different operation methods. In this case, the game system 1 may provide a difference in the drift state depending on the operation method.

### [2-2. Power-Charge State]

The power-charge state is a state in which a power-charge run for performing the turbo run described above is performed independently of the drift run. That is, in the exemplary embodiment, the player object can perform a turbo run following the drift run, and can also perform a turbo run after a power-charge run. The details of the power-charge state will be described below.

In the exemplary embodiment, if a predetermined first power-charge condition is satisfied at the time of landing by the player object from the air, the player object enters the power-charge state. In the exemplary embodiment, the first power-charge condition is to satisfy the following first to third conditions.
First condition: an acceleration operation input and an action operation input are being made at the time of landing.
Second condition: the speed of the player object is faster than the transition speed.
Third condition: no directional operation input is made during the decision period based on the time of landing.

It should be noted that the content of the first power-charge condition is arbitrary, and in other embodiments, the first power-charge condition may exclude any of the first to third conditions, or may include conditions different from the first to third conditions.

As described above, the first condition and the second condition of the first power-charge condition are the same as the first condition and the second condition of the drift condition. It should be noted that in other embodiments, the transition speed of the second condition of the first power-charge condition may be set to a different value than the transition speed of the second condition of the drift condition. The decision period of the third condition of the first power-charge condition is the same as the decision period of the third condition of the drift condition.

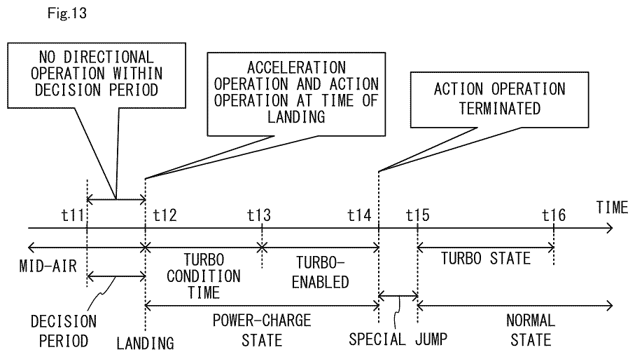

FIG. 13 is a diagram showing an example of transitions over time of the running state of the player object when a power-charge run is performed. In the example shown in FIG. 13, it is assumed that the player object has landed at time t12 from the state of being mid-air. It is also assumed that the acceleration operation input and the action operation input are being made at time t12. It is assumed that the speed of the player object at the time of landing is faster than the transition speed. Furthermore, it is assumed that no directional operation input is being made during the decision period from time t11 to time t12. Thus, in the example shown in FIG. 13, since the first to third conditions of the first power-charge condition are each satisfied, the game system 1 determines that the power-charge condition is satisfied and sets the player object to the power-charge state after landing.

As described above, when the first condition and the second condition are satisfied at the time of landing of the player object, if a directional operation input is being made during the decision period (FIG. 8), the player object enters the drift state as a result of the drift condition being satisfied, and if no directional operation input is being made during the decision period (FIG. 13), the player object enters the power-charge state as a result of the power-charge condition being satisfied. That is, when the first condition and the second condition are satisfied, the player can selectively choose the running state of the player object after landing (i.e., the drift state or the power-charge state) depending on whether or not the directional operation input is made within a certain period (i.e., the decision period) before landing including the point of landing.

In the exemplary embodiment, the player object can transition to the power-charge state while running on the ground, as well as at the time of landing from the air. That is, the game system 1 determines the second power-charge condition while the player object is running, and if the second power-charge condition is satisfied, the player object is set to the power-charge state.

In the exemplary embodiment, the second power-charge condition is satisfying the following first to third conditions.
First condition: the player object is on the ground.
Second condition: the acceleration operation input is being made and the action operation input is continuing.
Third condition: the speed of the player object has exceeded a predetermined transition speed.

It should be noted that the content of the second power-charge condition is arbitrary, and in other embodiments, the second power-charge condition may exclude any of the first to third conditions, or may include conditions different from the first to third conditions.

Regarding the second condition, “the action operation input is continuing” refers not to the timing at which the action operation input was started, but to the action operation input, which was started in the past, having been continuing. It should be noted that if the acceleration operation input and the action operation input are started in a situation where the first and third conditions are satisfied, the second power-charge condition is not satisfied and the player object performs a normal jump in response to the action operation input.

The transition speed of the third condition of the second power-charge condition is the same as the transition speed of the second condition of the first power-charge condition. It should be noted that they may be different values in other embodiments.

As in the first to third conditions, the second power-charge condition does not require the player object to be at the time of landing, so the second power-charge condition may be satisfied in situations where the player object is on the ground. Regarding the third condition, “has exceeded a predetermined transition speed” refers to the speed of the player object having changed from being less than or equal to the transition speed to being greater than the transition speed. That is, if the speed of the player object gradually increases, the third condition is satisfied when the speed of the player object first becomes greater than the transition speed, and the third condition is not satisfied after the speed of the player object becomes greater than the transition speed.

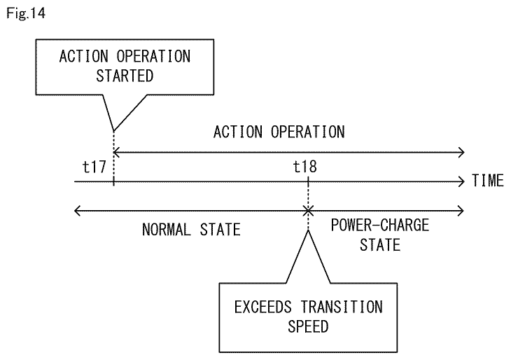

FIG. 14 is a diagram showing another example of transitions over time of the running state of the player object when a power-charge run is started. In the example shown in FIG. 14, the player object is running on the ground in the normal state, and the action operation input is started at time t17, when the speed of the player object is lower than the transition speed, and it is assumed that the action operation input is continued thereafter. Although not shown in the figure, it is assumed that the acceleration operation input is constantly made and the player object is accelerating. Thus, in the example shown in FIG. 14, the first condition and the second condition are satisfied after time t17 and, at time t18, the third condition is satisfied and the second power-charge condition is satisfied. As a result, at time t18, the player object transitions from the normal state to the power-charge state.

As described above, in the exemplary embodiment, the player object can run in the power-charge state not only when the condition is satisfied at the time of landing from the air, but also when the speed of the player object running in the normal state while the action operation input is continued exceeds the first speed (more specifically, when the acceleration operation input is further made). This makes it easy for the player object to transition to the power-charge state. It should be noted that in other embodiments, the conditions for transitioning the player object to the power-charge state are arbitrary. For example, in other embodiments, the game system 1 may use only the first power-charge condition without using the second power-charge condition. In the exemplary embodiment, the control of the player object in the following power-charge state is the same between the case where the first power-charge condition is satisfied and the case where the second power-charge condition is satisfied. However, in other embodiments, the game system 1 may provide a difference between the power-charge state in the case where the first power-charge condition is satisfied and the power-charge state in the case where the second power-charge condition is satisfied.

In the exemplary embodiment, the power-charge state of the player object is sustained as long as the action operation input is continued. That is, the player object is in the power-charge state while the first R-button 60 is pressed as the action operation input to start the power-charge state, and the power-charge state is cancelled in response to discontinuation of pressing of the first R-button 60.

It should be noted that in other embodiments, the operation to cancel the power-charge state is arbitrary and is not limited to the operation to end the action operation input. For example, in other embodiments, the power-charge state may be sustained even after the pressing of the first R-button 60 corresponding to the action operation input is ended, in which case the power-charge state may be cancelled by pressing the first R-button 60 again. For example, the power-charge state may be cancelled by a different operation input than the action operation input, for example, in response to another button different from the first R-button 60 being pressed.

It should be noted that in the exemplary embodiment, the operation input to cancel the power-charge state is the same as the operation input to cancel the drift state. This makes the operation related to the drift run and the power-charge run easier for the player to understand, thus improving operability.

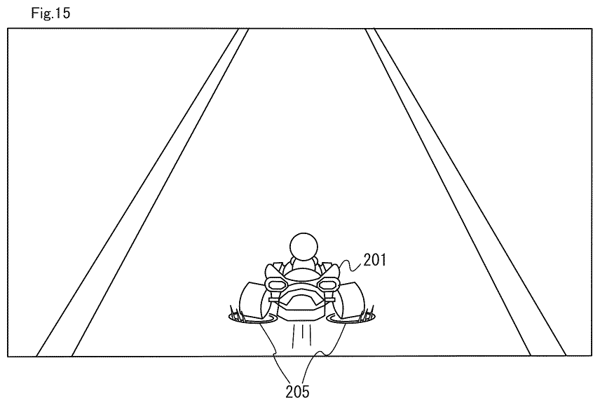

FIG. 15 is a diagram showing an example of a game image when the player object is performing a power-charge run. The appearance of the player object 201 in the power-charge state is different from the appearance of the player object 201 in the normal state and the drift state. In the exemplary embodiment, the player object 201 in the power-charge state looks more pressed (as if it were charging power) than in the normal state and the drift state (see FIG. 15). The game system 1 also displays the player object 201 in the power-charge state in a manner of display with a special effect image 205 of a glow on the ground around the rear wheels (see FIG. 15). It should be noted that the special effect image 205 is not attached to the player object in the normal state and in the drift state. That is, the special effect image displayed differs between the case where the player object is in the drift state and the case where the player object is in the power-charge state. This allows the player to recognize that the player object is in the power-charge state. It should be noted that the method of varying the manner of display of the player object to allow the player recognize the power-charge state is arbitrary. In other embodiments, the game system 1 may vary the manner of display of the player object by either only changing the appearance (e.g., its shape) of the player object, or attaching the special effect image 205. The special effect image 205 is an example, and other special effect images may be displayed.

In the exemplary embodiment, the behavior of the player object in response to the operation input by the player varies between the power-charge state and the normal state. That is, the game system 1 varies the method of controlling the player object between the power-charge state and the normal state. In the exemplary embodiment, in the power-charge state, the game system 1 controls the player object so that the cornering performance is lower than in the normal state and that the player object runs at a slower speed than in the normal state. Thus, it can be said that the power-charge state is a running state that is disadvantageous in the race game. However, as described below, the player object can perform a turbo run after the power-charge state, so the player object is not simply disadvantaged in the game by running in the power-charge state. In the exemplary embodiment, an advantageous turbo run is allowed after a disadvantageous power-charge run, so the player is given a choice between performing a power-charge run for an advantageous turbo run and performing a normal run to avoid the disadvantageous power-charge run, thereby generating a strategic aspect in the race game.

It should be noted that “running at a slower speed than the normal state” means, for example, that the maximum speed of the player object while running is lower than in the normal state. Specifically, the game system 1 sets the speed that the player object can reach when the acceleration operation input is made continuously in the power-charge state to be slower than that in the normal state.

“The cornering performance being lower than in the normal state” means, for example, that the minimum turning radius when the player object turns a corner is larger than in the normal state. It should be noted that as mentioned above, the minimum turning radius in the drift state is smaller than in the normal state. Therefore, the minimum turning radius in the power-charge state is larger than in the drift state. Therefore, when the player object is running on a straight heading into a corner in the race game, for example, the player performs game operations while deciding whether to perform a power-charge run on the straight in an attempt to achieve the turbo state before entering the corner or to refrain from performing a power-charge run on the straight to ensure that the player object will successfully drift around the corner. Thus, by setting a disadvantage to the power-charge state compared to the drift state, it is possible to improve the strategic aspect of the race game.

It should be noted that “the cornering performance of the player object being low” is not limited to the minimum turning radius being large as described above. As another example, “the cornering performance of the player object being low” may mean that the upper speed limit at which the player object can travel without spinning when turning a corner with a certain turning radius is low.

The method of controlling the player object in the power-charge state is arbitrary and is not limited to the above. For example, in other embodiments, the game system 1 may only perform either a control of making the cornering performance in the power-charge state lower than in the normal state or a control of making the maximum speed lower than in the normal state. In other embodiments, the power-charge state need not be a running state that is disadvantageous in the race game, and the behavior of the player object in response to an operation input by the player may be the same in the power-charge state and in the normal state.

It should be noted that in the exemplary embodiment, the player object may enter the power-charge state during a turbo run. In this case, the moving direction of the player object is controlled by the control method in the power-charge state described above, and the speed is controlled by the control method in the turbo state. However, in a turbo run while in the power-charge state, the speed is controlled to be slower than in a turbo run while in the normal state. That is, in the case described above, the player object turns at a faster speed than in the power-charge state while not in a turbo run but in the same manner as in the power-charge state. It should be noted that in other embodiments, the speed of the player object in a turbo run while in the power-charge state may be controlled so as to be a similar speed in a turbo run while in the normal state. In other embodiments, when the player object enters the power-charge state while in a turbo run, the player object may be controlled so as not to perform a turbo run. In other embodiments, the player object may be controlled so as not to enter the power-charge state while the player object is in a turbo run.

As shown in FIG. 13, in the exemplary embodiment, when the player object is in the power-charge state, if the power-charge state is continued for longer than the predetermined turbo condition time, the player object enters the turbo-enabled state described above. In the example shown in FIG. 13, the player object enters the turbo-enabled state at time t13, i.e., when the turbo condition time has elapsed since the player object entered the power-charge state at time t12. Specifically, the game system 1 counts the amount of time over which the power-charge state has continued, as a power-charge parameter, which indicates the degree of continuation of the power-charge state, and transitions the player object to the turbo-enabled state in response to the amount of time reaching the turbo condition time. It should be noted that the power-charge parameter may be any parameter whose value increases in accordance with the continuation of the power-charge state of the player object. For example, in other embodiments, the power-charge parameter may be a parameter that indicates the distance the player object has traveled since the player object entered the power-charge state. The amount of time until the turbo-enabled state is achieved may be shortened depending on operations performed while in the power-charge state. For example, the amount of time until the turbo-enabled state is achieved may be shortened by quickly switching the directional operation input left and right while in the power-charge state.

As described above, in the exemplary embodiment, the player object may enter the turbo-enabled state while in the power-charge state as well as while in the drift state. It should be noted that the turbo condition time in the power-charge state may be the same length as the turbo condition time in the drift state, may be shorter than the turbo condition time in the drift state, or may be longer than the turbo condition time in the drift state.

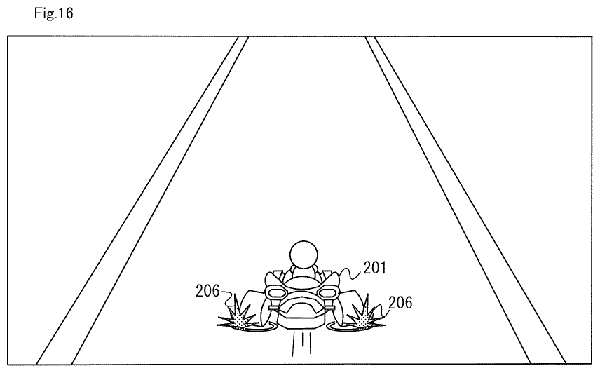

FIG. 16 is a diagram showing an example of a game image when the player object performing a power-charge run has entered the turbo-enabled state. As shown in FIG. 16, the player object 201 is displayed in a manner of display with a special effect image 206 of sparks. This allows the player to recognize that the player object is in the turbo-enabled state. It should be noted that the spark special effect image 206 is different in color from the spark special effect image 203 that is displayed when the player object performing a drift run enters the turbo-enabled state. It should be noted that the special effect image 206 is an example, and other special effect images may be displayed. For example, instead of, or in addition to, the spark special effect image, a special effect image representing energy being propagated or a special effect image representing smoke may be displayed.

In the exemplary embodiment, the turbo-enabled state in a power-charge run is also divided into three stages from the first stage to the third stage, as is the turbo-enabled state in a drift run. It should be noted that the amount of time until the turbo-enabled state reaches the second stage or the third stage may be the same or different between a drift run and a power-charge run. Also with the turbo-enabled state in a power-charge run, as with the turbo-enabled state in a drift run, the manner of display (specifically, the color) of the special effect image 206 indicating the turbo-enabled state varies depending on the stage of the turbo-enabled state. The number of stages of the turbo-enabled state during a power-charge run may be more or less than the number of stages of the turbo-enabled state during a drift run.

As shown in FIG. 13, the game system 1 causes the player object to run in the power-charge state while the action operation input that was performed at the start of the power-charge state is continued, and the game system 1 causes the player object to run in the turbo state in response to ending of the continued action operation input after the power-charge parameter has reached a predetermined value (i.e., after the amount of time over which the power-charge state has continued reaches the turbo condition time). According to this, the player can easily perform operations to cause the player object to perform a power-charge run and the following turbo run, since the player can instruct the start and end of the power-charge state by starting and ending the button pressing in a single action operation input.

In the exemplary embodiment, the game system 1 causes the player object to perform a normal jump action in response to an action operation input while the player object is running. Then, the player object is caused to perform a special jump action, which is different from the normal jump, in response to ending of the action operation input, which was continued at and after landing from the normal jump action, after the power-charge parameter reaches a predetermined value (time t14 shown in FIG. 13). In the example shown in FIG. 13, the player object performs a special jump action in the period from time t14 to time t15 in response to the power-charge state being cancelled at time t14 when the player object was running in the power-charge state. This allows the player to easily recognize that the power-charge state has ended. In addition, since the player can perform an operation input for starting the power-charge state and an operation input for ending the power-charge state using the same button, the operation can be consistent, and it is possible to provide an operation that is intuitive and easy-to-understand for the player. It should be noted that in the exemplary embodiment, the normal jump action and the special jump action are different in terms of the content of action, but in other embodiments, they may be of the same content of action.

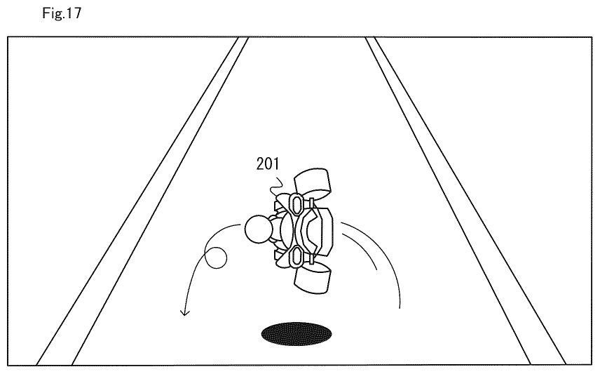

In the exemplary embodiment, as shown in FIG. 13, when the player object lands from the special jump, the player object returns to the normal state and enters the turbo state. That is, in the exemplary embodiment, the player object starts accelerating in response to landing from the special jump. Therefore, in the exemplary embodiment, it can be said that the special jump is a jump action that enables a turbo run after landing. In the example shown in FIG. 13, the player object performs a turbo run in the period from time t15 to time t16. The control of the player object in the turbo state following the power-charge state is similar to that in the turbo state following the drift state. As described above, as the player object performs a turbo run after landing from the special jump, the player is allowed to predict where the player object will land and determine the position at which to perform a special jump so that the player object can land at an appropriate position for the following turbo run, thereby generating a strategic aspect. It should be noted that when the acceleration operation input is discontinued while the player object is in the power-charge state, the player object will return to the normal state without performing a special jump. FIG. 17 is a diagram showing an example of a game image when the player object is performing a special jump. After the player object lands from the special jump action, the game system 1 causes the player object to run in the turbo state.

It should be noted that the game system 1 may set the player object to the turbo state immediately after landing from the special jump, after a predetermined amount of time for a special effect elapses, or after a predetermined distance is traveled, for example. While there is no particular limitation on the speed control of the player object during the special jump, the game system 1 may, for example, control the player object to maintain its previous speed during the special jump, or start accelerating the player object during the special jump. It should be noted that as in the exemplary embodiment, if the player object is set to the turbo state in response to landing from the special jump, the timing at which to enter the turbo state easier for the player to understand. If the player object starts accelerating during the special jump, it may be difficult for the player to predict the landing position of the special jump, whereas according to the exemplary embodiment, the player object accelerates after the special jump, so it is easier for the player to predict the position of landing from the special jump.

In the exemplary embodiment, when performing the special jump, the player object performs an action in response to the directional operation input at the start of the special jump action. For example, the example shown in FIG. 17 shows a case where a directional operation input to the left is made upon ending of the continuous action operation input, in which case, the player object 201 jumps so as to move parallel in the left direction while performing a leftward side roll action (if the player object 201 is moving forward, the player object 201 will jump so that it moves parallel to the left (in the case where the player object 201 is moving forward, the player object 201 will consequently move in the left-front direction). Similarly, the player object jumps while performing a rightward side roll, a forward roll, and a backward roll action in response to a right, up, and down directional input, respectively. It should be noted that if there is no directional operation input, the player object jumps without a roll. It should be noted that in the exemplary embodiment, the speed of the player object in the moving direction is controlled so as not to change regardless of the action. Regardless of whether the action is a forward roll or a backward roll, the landing position of the player object will be the same as when there is no directional operation input.

As described above, in the exemplary embodiment, based on a directional operation input that is made upon ending of the continuing action operation input, the game system 1 causes the player object to perform a jump action in response to the directional operation input, as a special jump action. Thus, with the special jump action, it is possible to improve playability. Also, the player can easily distinguish between a normal jump and a special jump. It should be noted that in other embodiments, the special jump action does not have to be in response to a directional operation input, and the special jump action may be an action that does not involve an action in response to a directional operation input.

It should be noted that in the exemplary embodiment, in a normal jump, the player object shifts its position slightly to the left or right while turning slightly in response to a directional operation input in the left-right direction performed at the time of the jump. On the other hand, in a special jump, the player object can change its position relatively significantly to the left or right in response to a directional operation input in the left-right direction performed at the time of the jump. It should be noted that in other embodiments, the game system 1 may control the jump action by the player object so that the player object relatively changes its position forward or rearward in response to a directional operation input in the up-down direction performed at the time of the jump.

As described above, in the exemplary embodiment, based on a directional operation input that is made at the end of a continued action operation input, the game system 1 causes the player object to perform, as a special jump action, a jump action in which the player object moves by an amount of movement larger than that of a normal jump in a direction in accordance with the directional operation input. According to this, the range of adjustment of the position at which the player object performs a turbo run after landing from the special jump is wide, thereby improving the range of selection of the position at which to perform a turbo run following a power-charge run. It should be noted that in other embodiments, the amount of movement of a special jump may be the same as the amount of movement of a normal jump, or the amount of movement of a normal jump may be greater than the amount of movement of a special jump.

It should be noted that although not shown in the figure, if the power-charge state is cancelled before the player object enters the turbo-enabled state during a power-charge run, the player object will return to the normal state without entering the turbo state. In this case, the player object will neither perform a special jump nor a normal jump.

In the exemplary embodiment, the power-charge state of the player object is ended not only when the action operation input is ended but also when no acceleration operation input is made. It should be noted that if an acceleration operation input is discontinued during the power-charge state, the player object will be in the normal state without entering the turbo state. In other embodiments, the game system 1 may allow the power-charge state to be continued even if an acceleration operation input is discontinued during the power-charge state.

In the exemplary embodiment, when a directional operation input is made while the player object is in the power-charge state, the power-charge state is continued, but in other embodiments, the game system 1 may end the power-charge state and set the player object to the normal state. In other embodiments, in such a case, the game system 1 may transition the player object from the power-charge state to the drift state.

In other embodiments, the game system 1 may cause the player object to perform a turbo run in response to the power-charge state having been continued for a predetermined period of time, regardless of whether an operation input to cancel the power-charge state is performed or not. In this case, the player object may be set to the normal state, or the power-charge state may be continued.

As described above, in the exemplary embodiment, the player can cause the player object to perform a power-charge run. By performing a power-charge run, the player object can run at high speed during a turbo run following the power-charge run. While the drift run described above is easy to perform on a corner of the race course, it is difficult to perform on a straight, but a power-charge run is easy to perform on a straight. That is, by causing the player object to perform a drift run in a corner section and a power-charge run in a straight section, and the player can cause the player object to perform a type of run that leads to a turbo run in either section.

It should be noted that in the exemplary embodiment, the game system 1 displays the player object on the display 12 in different manners of display between the drift state and the power-charge state (see FIG. 9 and FIG. 15). Here, in the exemplary embodiment, an operation for the drift state and an operation for the power-charge state are distinguished based on whether or not a directional operation input is made during the decision period described above, so that it is possible that a player who intends to have the player object perform a drift run may unintentionally have the player object perform a power-charge run, and vice versa. In the exemplary embodiment, the manner of display of the player object is varied between the drift state and the power-charge state, thereby reducing the possibility that the player misunderstands the current running state of the player object.

### [2-3. Object Run State]

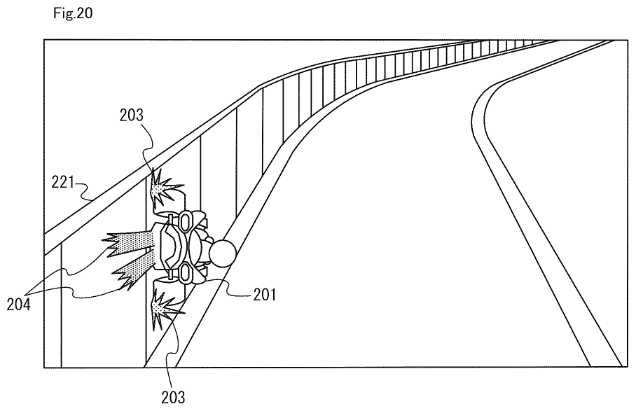

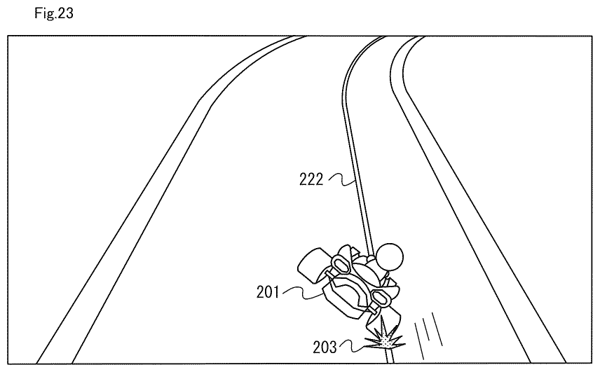

The object run state is a state in which the player object runs on a predetermined runnable object arranged in the virtual space. A runnable object is an object on which the player object can run. In the exemplary embodiment, wall objects and rail objects to be described below are arranged in the virtual space as runnable objects. In the exemplary embodiment, as an object run in which the player object runs on a runnable object, the player object runs on the wall surface of a wall object (see FIG. 20) or runs on a rail object (see FIG. 23).

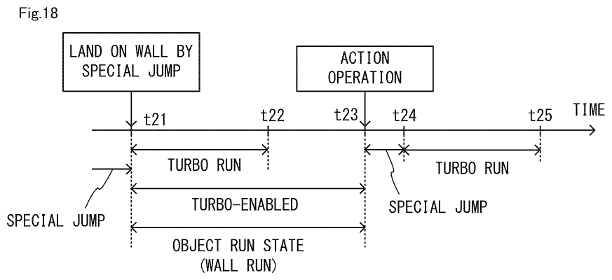

First, referring to FIG. 18 to FIG. 20, an example where the player object performs a wall run will be described. FIG. 18 is a diagram showing an example of transitions over time of the running state of the player object when a wall run is performed. Here, in the exemplary embodiment, the game system 1 causes the player object to start running on a runnable object when the player object satisfies a predetermined object run condition. In the exemplary embodiment, the object run condition regarding a wall run includes a condition that the player object come in proximity to a runnable object as a result of a special jump. In the example shown in FIG. 18, the player object starts a wall run in response to the player object coming in proximity to a wall object at time t21 as a result of a special jump performed by the player object.

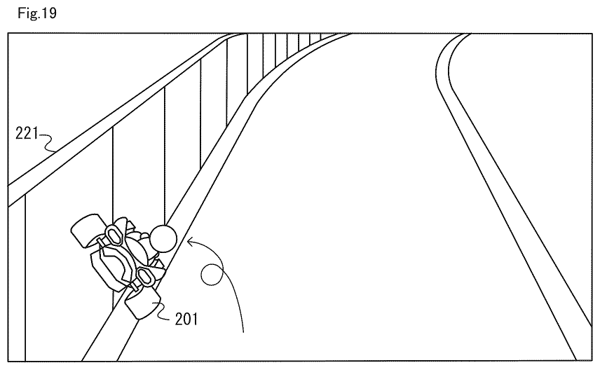

FIG. 19 is a diagram showing an example of a game image when the player object is performing a special jump. FIG. 20 is a diagram showing an example of a game image when the player object is performing a wall run. The situation shown in FIG. 19 is a situation where the player object 201 has performed a special jump while in the power-charge state near a wall object 221. In this case, in response to the player object 201 coming in proximity to the wall object 221, the player object 201 starts a wall run on the wall object 221 as shown in FIG. 20.

It should be noted that the wall object 221 shown in FIG. 19 and FIG. 20 is a wall that is placed beside a road, but objects that function as wall objects in the virtual space are not limited to this. For example, a wall object may be any object having a surface that has a predetermined range of angles (e.g., angles in the range of 80° to 110°) relative to the ground of the virtual space. Specifically, a building object or a cliff terrain object may function as a wall object, and the player object may run on the side surface of the building object or the slope of the cliff in the object run state. The wall object need not be an object that is fixedly arranged in the virtual space, but may be an object that moves around in the virtual space. For example, a train object moving around in the virtual space may function as a wall object, and the player object may run on the side surface of the moving train in the object run state.

As described above, in the exemplary embodiment, runnable objects include a wall object provided in the virtual space, and the game system 1 causes the player object to run on the wall surface of the wall object. According to this, a wall object, which normally (i.e., when the object run condition is not satisfied) is an obstacle, can also function as a runnable object. It is possible to increase the number of paths that the player object can take in the race game, and it is possible to give the player a choice between running on a normal road and running on a wall object. Furthermore, in order to cause the player object to perform a wall run, the player will perform game operations while considering whether or not the player object is in a state where the player object can perform a special jump, whether or not the player object can reach the wall object by performing a special jump, etc. This can improve the strategic aspect of the race game. It should be noted that in other embodiments, wall objects as runnable objects may not be provided in the virtual space.

In the exemplary embodiment, the player object can perform a wall run by performing a special jump following the power-charge run described above. That is, the game system 1 causes the player object to start a wall run in response to the object run condition being satisfied as the player object comes in proximity to a wall object by a special jump. Thus, since the player object starts a power-charge run some distance before a wall object in order to perform a wall run, the player is required to look at the arrangement of objects ahead in the course and perform game operations while determining whether or not a special jump following a power-charge run is possible. For example, before turning a corner where a wall object is arranged on the outside of the corner, the player performs game operations while determining whether to perform a power-charge run to get through the corner by a wall run or to refrain from performing a power-charge run to get through the corner by a drift run. This can improve the strategic aspect of the race game.

It should be noted that in other embodiments, the object run condition regarding a wall object is not limited to the player object coming in proximity to the wall object by a special jump, but may be any other condition. For example, the object run condition regarding a wall object may include a condition that the player object come in proximity to the wall object in the drift state or in the power-charge state. Thus, it is possible to increase the chance for the player object to perform a wall run, thereby improving the strategic aspect of the race game.

In the exemplary embodiment, the game system 1 determines that the player object has come in proximity to a wall object when the distance between the player object and the wall object becomes less than or equal to a predetermined value during a special jump by the player object. In this case, the game system 1 controls the player object to land on the wall object to start a wall run. It should be noted that the predetermined value may be 0. That is, the player object may be controlled to land on the wall object and start a wall run in response to the player object contacting the wall object.

It should be noted that in the exemplary embodiment, the object run condition regarding a wall run is a condition regarding the distance between the player object and the wall object, such as “the player object has come in proximity to a runnable object by a special jump”. In other embodiments, the object run condition may further include other conditions. For example, in other embodiments, the game system 1 may include, in addition to the condition regarding the distance between the player object and the wall object, conditions regarding the angle of entry of the player object relative to the wall object and/or the attitude of the player object relative to the wall object. The object run condition regarding a wall run is arbitrary, and in other embodiments may include no condition regarding the distance between the player object and the wall object.

In the exemplary embodiment, in addition to being able to perform a special jump by a power-charge run, the player object can also perform a special jump in other situations. As will be described in detail below, the player object can also perform a special jump in the object run state. The player object may also perform a special jump in response to an action operation input made at a specific location on the race course (e.g., a jump pad) or by colliding with a specific object in the virtual space (e.g., a specific character). The player object may also perform a special jump in response to an action operation input made when the player object comes off the ground at an unspecified location on the race course due to undulations of the race course, etc. For example, when the player object performs a normal jump from in front of a cliff and jumps off the cliff, the player object may perform a special jump in response to an action operation input made during the fall. In this case, the special jump may include a two-step jump where the player object jumps up again during a fall, or it may be an action in response to a directional operation input, such as a forward or sideways roll, without a two-step jump during a fall. In the exemplary embodiment, even if the player object performs a special jump due to a factor other than a power-charge run, the player object can perform a wall run by landing on a wall object from the special jump. According to this, it is possible to increase the chance for the player object to perform a wall run, thereby improving the strategic aspect of the race game.

In the exemplary embodiment, the game system 1 varies the method of controlling the player object between the object run state and the normal state. In the exemplary embodiment, in the object run state, the player object is controlled to move forward of the player object along the wall object. For example, the player object may be controlled to move diagonally upward rather than horizontally in the virtual space while moving along the wall object. As an example, the player object may be controlled to, while moving along the wall object, move in the up-down direction in accordance with the slope of the ground on which the wall object stands (e.g., the slope of the ground at the boundary between the wall object and the ground below the position at which the player object is touching the wall object).

In the exemplary embodiment, the game system 1 controls the moving direction of the player object in an object run state, regardless of the directional operation input by the player. In a wall run, the player object automatically moves in the direction along the wall object even without a directional operation input from the player. Here, during a wall run, the player object is facing sideways (see FIG. 20). Therefore, when the player object is to be moved in the up-down direction, the player may be confused as to whether the player should make a left-right direction input operation and an up-down directional operation input in order to cause the player object to move in the up-down direction on the wall. In the exemplary embodiment, the moving direction of the player object in the object run state is automatically controlled, thereby reducing the possibility of the player feeling awkward with the operation. It should be noted that in other embodiments, the game system 1 may control the moving direction of the player object in accordance with the directional operation input by the player in the object run state.

Also, as described above, in the exemplary embodiment, the player object performs a turbo run after landing from a special jump. Even after the player object lands on a wall object by a special jump, the player object performs a turbo run on the wall object. In the example shown in FIG. 18, the player object performs a turbo run from time t21 to time t22 after landing from the special jump. At this time, the game system 1 displays the special effect image 204 on the player object 201 indicating that the player object 201 is in the turbo state (see FIG. 20).

In the exemplary embodiment, in the object run state, unlike in the power-charge state or the drift state, the player object enters the turbo-enabled state at the start of an object run (see FIG. 18). As will be described in detail below, this allows the player object in the object run state to perform a special jump regardless of the amount of time over which the object run state has continued. As shown in FIG. 19, the player object 201 in the object run state is displayed with the special effect image 203 indicating that the player object 201 is in the turbo-enabled state.

In the exemplary embodiment, the turbo-enabled state while in an object run is not divided into multiple stages. It should be noted that in other embodiments, the turbo-enabled state in an object run may be divided into three stages from the first stage to the third stage, similar to the turbo-enabled state in a drift run or a power-charge run. In this case, the amount of time until the turbo-enabled state reaches the second stage or the third stage in an object run may be the same as, or different from, that in a drift run or a power-charge run. Also in the turbo-enabled state while in an object run, as in the turbo-enabled state while in a drift run or a power-charge run, the manner of display (specifically, the color) of the special effect image 203, indicating that the turbo-enabled state, may vary depending on the stage of the turbo-enabled state. The number of stages of the turbo-enabled state in an object run may be more or less than the number of stages of the turbo-enabled state during a drift run or a power-charge run.

In the example shown in FIG. 18, during a wall run, the player object performs a special jump in response to an action operation input at time t23. That is, a special jump is performed not in response to discontinuation of pressing of the first R-button 60, which had been pressed continuously, as in the drift state or the power-charge state, but a special jump is performed in response to pressing of the first R-button 60. Thus, in the exemplary embodiment, the player object can perform a special jump even in the object run state.

In the exemplary embodiment, the game system 1 always allows the player object to perform a special jump in response to an action operation input while in the object run state. That is, the player can cause the player object to perform a special jump immediately after entering the object run state. Here, a power-charge run described above can be performed relatively easily by a normal jump action regardless of the current position of the player object, whereas an object run can be performed by a special jump in a situation where a runnable object is arranged around the player object, and it can be said that an object run is more difficult to perform than a power-charge run. Therefore, in the exemplary embodiment, the player can immediately obtain an advantage of an object run (i.e., a special jump) when the player object performs an object run, thereby motivating the player to cause the player object to perform an object run. It should be noted that in other embodiments, the game system 1 may set the player object in a state in which the player object can perform a special jump on the condition that a parameter, whose value increases in accordance with the continuation of the object run state, have reached a predetermined value.

It should be noted that when performing a special jump during a wall run, the player object is controlled to perform a special jump in the direction away from the wall object, regardless of the directional operation input at the start of the special jump action.

In the example shown in FIG. 18, the player object performs a special jump at time t23, and then performs a turbo run in response to landing on the ground from the special jump at time t24. Then, during the period from time t24 to time t25, the player object performs a turbo run. The control of the player object while in the turbo state following the object run state is the same as that while in the turbo state following the power-charge state. Thus, in the exemplary embodiment, the player object can run at high speed by a turbo run also after the object run state as well as after the drift state or the power-charge state.

As described above, in the exemplary embodiment, the game system 1 causes the player object to run in the turbo state after landing from a special jump, regardless of the amount of time the player object has run on a runnable object. According to this, since it is possible to immediately obtain an advantage as the player object performs an object run, it is more likely to motivate the player to perform an object run. In the exemplary embodiment, since the player does not need to make a directional operation input in the object run state, if the object run state continues for a long time, the length of time for which the player makes no directional operation input may become long, thus detracting from the playability of the game. For this, in the exemplary embodiment, when the player object enters the object run state, there is immediately an advantage to make an action operation input, and it is possible to motivate the player to perform an action operation input. This can prevent the length of time for which the player performs no game operation from becoming long.

It should be noted that in other embodiments, in the object run state, as in the drift state and the power-charge state, the game system 1 may set the player object to the turbo-enabled state when a parameter that increases as the player object continues an object run reaches a predetermined value. For example, the game system 1 may cause the player object to run in the turbo state after landing from a special jump when the amount of time over which the player object has run on a runnable object is equal to or greater than the turbo condition time. It should be noted that in the description above, the turbo condition time in the object running time may be set shorter than the turbo condition time in the power-charge state. According to this, as in the exemplary embodiment, it is possible to motivate the player to cause the player object to perform an object run.

It should be noted that in the exemplary embodiment, the player object can perform a wall run within a predetermined wall run limit time. That is, the game system 1 causes the player object to run off the wall object when the object run state of the player object continues for the wall run limit time. In this case, the player object returns to the normal state without performing a special jump and resumes running on the course. In this case, no turbo run is performed. It should be noted that the wall run limit time may be a fixed value, or it may be variable based on, for example, the speed of the player object and/or the state (e.g., position and shape) of the wall object. For example, the wall run limit time may be set shorter when the speed of the player object is low than when the speed of the player object is high, and the wall run limit time may be set shorter when the wall object is arranged on the outside of the corner (i.e., when the wall object is curved toward the player object running on the wall object) than when the wall object is arranged on the inside of the corner (i.e., when the wall object is curved away from the player object running on the wall object). In other embodiments, the game system 1 may end an object run when the speed of the player object becomes less than or equal to a predetermined value.

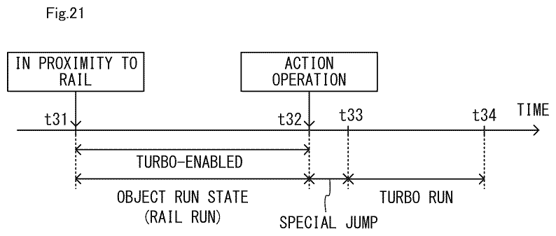

Next, referring to FIG. 21 to FIG. 23, an example where the player object performs a rail run will be described. In the exemplary embodiment, the player object can perform a rail run, as shown in FIG. 23. FIG. 21 is a diagram showing an example of transitions over time of the running state of the player object when a rail run is performed. Here, in the exemplary embodiment, the object run condition for a rail run includes a condition that the player object come in proximity to a rail object (specifically, the distance therebetween is less than or equal to a predetermined distance, which includes the case where the predetermined distance is zero, i.e., they are in contact with each other). In the example shown in FIG. 21, the player object starts a rail run in response to the player object coming in proximity to the rail object at time t31.

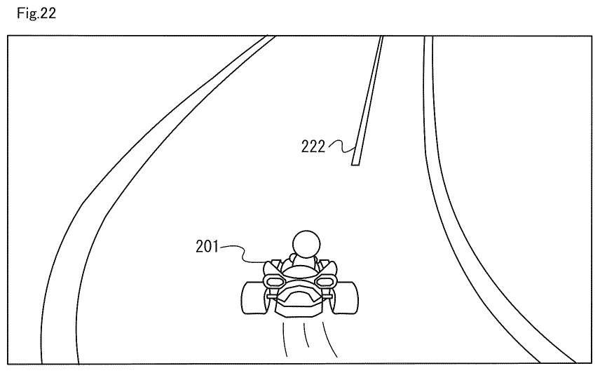

FIG. 22 is a diagram showing an example of a game image before the player object starts a rail run. FIG. 23 is a diagram showing an example of a game image when the player object is performing a rail run. The situation shown in FIG. 22 is a situation where the player object 201 is trying to enter the rail object 222 from a position before the rail object 222. In the exemplary embodiment, the rail object 222 has a rail path that allows a rail run by the player object 201. The player object 201 can perform a rail run along the rail path. It should be noted that in the exemplary embodiment, the rail path is invisible. In response to the player object 201 coming in proximity to the rail object 222 (including coming in proximity to the rail path), the player object 201 starts a rail run on the rail object 222, as shown in FIG. 23.

It should be noted that the rail object 222 for which the rail path is set, shown in FIG. 22 and FIG. 23, is a rail-shaped object set on the ground in the virtual space, but the object for which a rail path is set is not limited to this. For example, a rail path may be set on an outer edge of the rooftop of a building object. In this case, the player object performs a rail run on the outer edge of the rooftop the building object by coming in proximity to the outer edge of the rooftop of the building object. In the exemplary embodiment, a portion of an object for which a rail path is set may be referred to as a “rail object”. Other examples of rail objects may be a railing portion of a railing object, an upper surface portion of a guardrail object, etc. Thus, the rail object may be located off the ground in the virtual space.

As described above, regarding a rail object, unlike a wall object, the player object can perform a rail run not only by landing on the rail object by a special jump, but also by coming in proximity to the rail object in any way. For example, as shown in FIG. 22 and FIG. 23, the player object can perform a rail run by coming in proximity to a rail object while in the normal state, or perform a rail run by coming in proximity to a rail object by a special jump, which is not shown. While a rail object is thinner than a wall object and it may be difficult for the player object to land on a rail object by a special jump, it is made easier to perform a rail run, thereby motivating the player to perform a rail run. It should be noted that in other embodiments, the object run condition regarding the rail object is arbitrary and is not limited to the above. For example, in other embodiments, the object run condition regarding a rail object may be the player object landing on the rail object, i.e., on the rail path, by a normal jump or a special jump.

It should be noted that in the exemplary embodiment, the object run condition regarding the rail run includes a condition regarding the distance between the player object and the wall object, such as “the player object coming in proximity to a runnable object”. In other embodiments, the object run condition may further include other conditions. For example, in other embodiments, the game system 1 may cause the player object to perform a rail run based on conditions regarding the angle of entry of the player object onto the rail path and/or the attitude of the player object relative to the rail path. Specifically, the player object may determine that the object run condition is satisfied when the angle of entry of the player object relative to the rail path less than or equal to a predetermined angle in a state where the distance between the player object and the rail path is less than or equal to a predetermined value. The object run condition may vary depending on the rail object or the rail path. For example, for rail paths that are arranged on the ground, the condition may be the angle of entry of the player object relative to the rail path, and for rail paths that are arranged off the ground, the condition may not be the angle of entry of the player object relative to the rail path. This can prevent a rail run from being started unintentionally when the player object moves intending to cross over a rail path that is on the ground. In addition, while it may be difficult to approach a rail path that is in the air, it is possible to reduce the risk of making it difficult to perform a rail run the condition further includes the angle of entry. It should be noted that the object run conditions for a rail run are arbitrary, and in other embodiments may not include a condition regarding the distance between the player object and the rail object.

In the exemplary embodiment, when performing a rail run, the player object is controlled to move along a rail object, specifically a rail path. It should be noted that while in the object run state, the moving direction of the player object is controlled regardless of the directional operation input by the player. Thus, when performing a rail run, the player object automatically moves in the direction along the rail object even without the directional operation input by the player.

As shown in FIG. 23, when performing a rail run, the player object 201 is in an attitude where the player object 201 runs on one wheel on the rail object 222 with one wheel raised. This allows the player to recognize that the player object 201 is performing a rail run. It should be noted that in the other embodiments, the rail object may consist of two parallel rails. In this case, the player object may perform a rail run with left and right tires on respective rails.

Also in a rail run, as in a wall run, the player object may perform a special jump regardless of the amount of time over which the object run state has continued.

It should be noted that in other embodiments, the game system 1 may vary the stages of the turbo-enabled state that the player object can take between a rail run and a wall run. In other embodiments, the game system 1 may vary the amount of time until the turbo-enabled state transitions to the next stage between a rail run and a wall run.

As shown in FIG. 23, when the player object 201 performs a rail run, the special effect image 203 indicating that the player object 201 is in the turbo-enabled state is displayed at a rear wheel that is in contact with the rail object 222.

In the example shown in FIG. 21, in a rail run, the player object performs a special jump in response to an action operation input made at time t32. Then, the player object performs a special jump during the period from time t32 to time t33, and performs a turbo run until time t34 after landing from the special jump. Here, in a rail run, as in a wall run, the player object can perform a special jump from the start of the object run state. It should be noted that when performing a special jump while in a rail run, the player object performs a special jump with an action corresponding to a directional operation input made at the start of the special jump action, as is the case when performing a special jump while in a power-charge run. For example, if a directional operation input of the right direction is made when performing a special jump, the player object 201 performs a special jump so that the player object 201 moves rightward while performing a rightward roll action. In the case of performing a special jump while in a rail run, as in the case of performing a special jump while in a wall run, the player object performs a turbo run after landing from the special jump.

As described above, in the exemplary embodiment, the player object can perform a special jump and a turbo run after landing from the special jump while in three different states: the power-charge state, the wall run state, and the rail run state. Here, the speed control (e.g., degree of acceleration and maximum speed) in a turbo run or the turbo limit time for a turbo run may be set the same, or different, for the three different states. For example, since a wall run is considered to be more difficult to perform than the other two types, the game system 1 may increase the degree of acceleration in a turbo run or increase the turbo limit time for a wall run so that the player can obtain a greater advantage in accordance with the difficulty level of execution.

It should be noted that in the exemplary embodiment, for a rail run, unlike a wall run, there is no limit time for continuing a rail run. That is, the player object can run on a rail object until the end of the rail object. When the player object reaches the end of the rail object, the player object will continue running off the rail object. In this case, the player object does not perform a turbo run because no special jump is performed. However, in other embodiments, even in such a case, the player object may perform a special jump after a rail run and perform a turbo run after landing. In other embodiments, a limit time for which a rail run can be continued may be set, as with a wall run. The game system 1 may control the player object to run off the rail object in response to a directional operation input in the left-right direction during a rail run.

As described above, in the exemplary embodiment, as runnable objects, the virtual space includes wall objects as objects of the first type and rail objects as objects of the second type. The object run condition for objects of the first type includes a condition that the player object come in proximity to an object of the first type by a special jump. The object run condition for objects of the second type includes a condition that the player object come in proximity to an object of the second type, whether by a special jump or not. According to this, it is possible to increase the variation of the object run, thereby improving the playability of the race game. For example, when two types of objects are both placed along a certain section of the race course, the player is given a number of choices, i.e., performing an object run by using an object of the first type, performing an object run by using an object of the second type, and running without using any runnable object. This can improve the strategic aspect of the race game. It should be noted that in other embodiments, runnable objects do not need to include either or both of the first and second types of objects described above, and may include objects of a different type.

It should be noted that since rail objects are deliberately provided by the designer by setting rail paths in the virtual space, it may be difficult for the designer to set many rail paths in the vast virtual space. With wall objects, on the other hand, since the wall surface of any object provided in the virtual space can be used as a wall object, as the designer sets objects such as buildings and obstacles in the virtual space, it is possible to naturally set many wall objects without the designer deliberately setting runnable objects. Thus, it is easy to set many wall objects in the virtual space, and it is therefore possible to give the player with many chances to perform a wall run. It is also possible to give the player chances to enjoy discovering paths that can be traveled by a wall run in various locations in the virtual space. It should be noted that in the exemplary embodiment, the game system determines that an object having a surface with a predetermined range of angles relative to the ground in the virtual space is a wall object, but the method of determining whether or not an object is a wall object is not limited to this. For example, in other embodiments, surfaces of objects arranged in the virtual space may be assigned information indicating that they are runnable wall surfaces so that those surfaces assigned such information function as wall objects.

In the exemplary embodiment, the player object can perform an object run also by coming in proximity to a runnable object by way of a special jump. Here, the player object can also perform a special jump during an object run. Therefore, the player object can further perform an object run by landing on a runnable object from a special jump during an object run. This allows the player object to repeat object runs and special jumps.

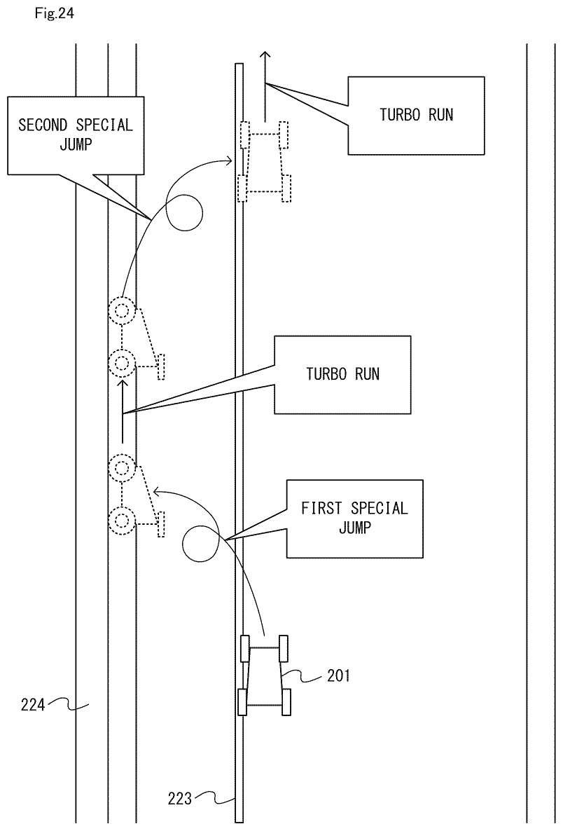

FIG. 24 is a diagram showing an example of the player object performing consecutive special jumps. In the example shown in FIG. 24, the player object 201 is in the object run state in which the player object 201 is running on a rail object 223. While running on the rail object 223, the player object 201 performs a first special jump and lands on a wall object 224, thereby starting an object run on the wall object 224. Furthermore, the player object 201 performs a second special jump during an object run on the wall object 224 and lands on the rail object 223, thereby again starting an object run on the rail object 223. It should be noted that since the player object 201 performs a turbo run after a special jump, the player object 201 can repeat turbo runs and special jumps by repeating special jumps on runnable objects as shown in FIG. 24.

This allows the player object 201 to run at high speed on the race course. Therefore, it is possible to more strongly motivate the player to cause the player object to perform an object run. When jumping from one rail object to another rail object by a special jump, the player object may not be able to successfully jump onto the other rail object and fall on the course, depending on the positional relationship between the two rail objects. Therefore, the player is required to perform a special jump while determining the position from which a successful jump can be made, thereby improving the strategic aspect of the race game.

It should be noted that the description above shows an example in which the player object repeatedly performs turbo runs while jumping between different runnable objects, but in the exemplary embodiment, the player object can also repeatedly perform special jumps and turbo runs on the same runnable object. For example, by performing a special jump while running on a rail object and then returning onto the same rail object, the player object can continue to run on the rail object by a turbo run, and can further enter the turbo-enabled state. It should be noted that if an action operation input that does not involve a directional operation input in the left-right direction is made while in a rail rum, the player object will maintain the previous running direction and perform a special jump. Therefore, if the player object performs a special jump in a situation where the rail object (rail path) is curved, the player object may not land on the same rail object and may not be able to continue running on the runnable object. That is, a strategic aspect is generated in that the player is challenged to determine, while running on a rail object, the timing at which the player object can return onto the same rail object, and cause the player object to perform a special jump. It should be noted that, for example, if the player object is running on a rail object that is curved to the right, the player can make an action operation input with a directional operation input to the right so as to cause the player object to perform a special jump to the right, aiming to have the player object land again on a portion of the rail object past the right curve. On the other hand, regarding the wall object, for example, if the player object performs a special jump while running on a flat wall object (i.e., on a wall surface that extends horizontal with the moving direction of the player object), the player object will run off the wall object. However, if the wall object is arranged on the outer side of a corner (i.e., if the wall object is curved toward the player object running on the wall), even if the player object moves away from the wall object by performing a special jump, the player object can land on the same wall object again as the wall object is curved toward the player object. This generates a strategic aspect in that the player is challenged to determine the shape of the wall object and perform a special jump at the appropriate timing.

It should be noted that in the exemplary embodiment, the game system 1 causes the player object to run in the turbo-enabled state regardless of the amount of time over which the player object has run on a runnable object. This also allows the player object to perform a special jump immediately after landing on a runnable object by a special jump. In this case, the player object can run at high speed on the course by repeatedly performing turbo runs without an interval. In the exemplary embodiment, the player does not need to make a directional operation input during an object run, so there is a risk that the player may become bored during an object run. For this, in the exemplary embodiment, the player object can perform a special jump that leads to a turbo run at any timing during an object run, thus reducing the possibility of the player feeling bored during an object run. This can improve the playability of game operations during an object run.

As described above, in the exemplary embodiment, since the player object can repeat special jumps without an interval, the player object can also perform the next special jump during a turbo run following a special jump. If the next turbo run is started before the turbo limit time for a turbo run by the player object has elapsed (i.e., if the second turbo run is started in response to landing from a special jump after the first turbo run), the game system 1 will reset and re-count the time the player object has been in a turbo run. That is, the game system 1 counts the elapsed time from a point of time the next turbo run was started, and allows the player object to perform a turbo run until the elapsed time reaches the turbo limit time. However, in other embodiments, the specific method of counting the time the player object has been in a turbo run is arbitrary. For example, the game system 1 may start counting the elapsed time for the second turbo run when the turbo limit time for the first turbo run has elapsed, and cause the player object to perform a turbo run until the elapsed time reaches the turbo limit time.

In the exemplary embodiment, if the player object performs a special jump in a turbo run, the player object is controlled to run at the same speed during a special jump and during a turbo run. That is, in the case described above, it can be said that a turbo run is continued during a special jump. Thus, it is possible to reduce unnatural behavior such as frequent speed changes when the player object repeats special jumps and turbo runs. It should be noted that in other embodiments, the game system 1 may control the speed of the player object to gradually decelerate during a special jump, or may set the speed of the player object during a special jump to the same speed as in the normal state.

In the exemplary embodiment, the race game executed by the game system 1 has a game mode in which the player object competes for position with one or more opponent objects. In this game mode, the game system 1 controls the running of the opponent objects, which are different from the player object, participating in the race game. It should be noted that the opponent objects may be automatically controlled, or the opponent objects may be controlled by other players different from the player of the game system 1. That is, the opponent objects may be automatically controlled according to a predetermined algorithm included in the game program, or the game system 1 may acquire data indicating operations by other players from other game systems and control the opponent objects according to such data.

Here, in a situation where two mobile objects (i.e., the player object or the opponent objects) are running on a single rail object, if a mobile object located behind collides with a mobile object located in front, the front mobile object is controlled to run off the rail object. According to this, for example, when the player object is located in front of the opponent object on a rail object, the player is required to decide whether to run off the rail object to avoid being collided with the opponent object, or to maintain the rail run. This improves the strategic aspect of the race game.

It should be noted that in the exemplary embodiment, when a first mobile object runs off a rail object due to a collision from a second mobile object located behind, the first mobile object is controlled not to perform a turbo run after running off the rail object. Then, the disadvantage of being collided with is significant, which further improves the strategic aspect of the race game. However, in other embodiments, even in this case, a mobile object may be controlled to perform a turbo run after running off the rail object.

In the exemplary embodiment, weight information may be set for a car object and a character boarding the car object, which together form a mobile object. For example, when mobile objects collide with each other on a normal section of the course (not a runnable object), it is determined based on the weight information which of the colliding mobile objects will be bounced off. In contrast, on a runnable object, a mobile object located in front is controlled to run off the runnable object, regardless of the weight information of the colliding mobile objects. According to this, on a runnable object, even a heavy mobile object, which is difficult to be bounced off on a normal course, will run off the runnable object by collision if the mobile object is located in front. This further improves the strategic aspect on a runnable object, thereby further improving the playability of the race game.

It should be noted that in other embodiments, also when a mobile object runs on a runnable object (e.g., a wall object) other than a rail object, as in the case of running on a rail object, the game system 1 may control a mobile object located in front to run off the runnable object by a collision from another mobile object located behind. This can further improve the strategic aspect of the race game.

In the exemplary embodiment, a mobile object can use items in the race game. In the exemplary embodiment, items are attack items for attacking other mobile objects. It should be noted that the types of items that appear in the race game are arbitrary, and in other embodiments, there may be items that temporarily increase the speed of the mobile object that uses the item, or that render the mobile object that uses the item invincible (e.g., the mobile object nullifies attack items from other mobile objects). It should be noted that in the exemplary embodiment, a mobile object can obtain an item by contacting an item box object arranged in the virtual space. However, the method by which a mobile object obtains an item is arbitrary and is not limited to the above method. For example, a mobile object may have unlimited or limited access to items, as an ability unique to the mobile object.

In the exemplary embodiment, as one of the items described above, a mobile object can use a first attack item that tracks and attacks other mobile objects. If a mobile object is hit by the first attack item, the mobile object spins and temporarily becomes unable to run. It should be noted that a mobile object to be attacked may be determined in any way, and may be determined, for example, based on the positional relationship between the mobile object that used the first attack item and other mobile objects. The mobile object to be attacked may be, for example, one of other mobile objects located within a predetermined angular range with respect to the front direction of the attacking mobile object that used the first attack item that is located closest to the attacking mobile object. A mobile object may use a second attack item as another attack item. The second attack item is fired straight in the front direction of the mobile object when used. The behavior of a mobile object when collided by the second attack item may be the same as the first attack item.

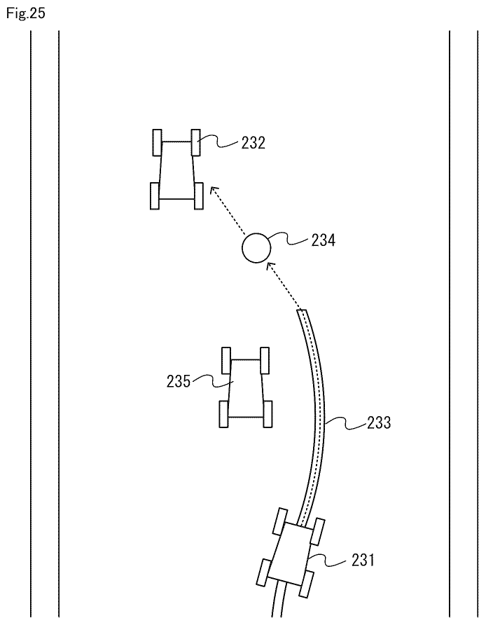

FIG. 25 is a diagram showing an example of how an attack item moves when a first attack item is fired while on a rail object. The situation shown in FIG. 25 is a situation in which a first attack item 234 is fired by a mobile object 231 running on a rail object 233. As shown in FIG. 25, when the first attack item 234 is fired by the mobile object 231 on the rail object 233, the first attack item 234 is controlled to move along the rail object 233. When the first attack item 234 moves off the rail object 233 at the end of the rail object 233, the first attack item 234 will track a mobile object 232 as the attack target based on its position at that point. It should be noted that in the situation shown in FIG. 25, if there is no rail object 233 (i.e., the mobile object 231 is not located on the rail object 233), the first attack item 234 is controlled to track the mobile object 235 as the attack target. It should be noted that if the second attack item is fired while on the rail object 233, the second attack item will move along the rail object 233 instead of moving straight. When the second attack item comes off the rail object 233 at the end of the rail object 233, the second attack item moves straight in the moving direction at that point. Thus, in the exemplary embodiment, the trajectory on which the attack item moves will vary depending on whether or not the attack item is fired while on a rail object.

Thus, the trajectory or behavior of an attack item will vary depending on whether the player object or another mobile object is performing a rail run. Therefore, the player is challenged to decide whether to perform a rail run depending on the type of items possessed by the player or by the opponents and whether or not the nearby mobile objects are performing a rail run, thereby improving the strategic aspect of the race game. It should be noted that in other embodiments, the game system 1 is not required to control an attack item to move along a rail object.

As shown in FIG. 25, after the first attack item 234, having moved along the rail object 233, moves off the rail object 233 at the end of the rail object 233, the game system 1 controls the first attack item 234 to move toward the mobile object 232, which is the attack target. Therefore, when the player object while in a rail run uses the first attack item, the player is given a choice between attacking an opponent object on the rail object by using the first attack item while on the rail object and attacking another opponent object by using the first attack item after running off the rail object. This can further improve the strategic aspect of the race game. It should be noted that in other embodiments, the game system 1 may control the first attack item to move straight after the first attack item moves off the rail object at the end of the rail object.

It should be noted that there may be an attack item that can be fired backward. If the mobile object is on a rail object, such an attack item may be controlled to move backward along the rail object. There may also be an attack item that can be placed on a rail object.

### [2-4. Course Set in Virtual Space]

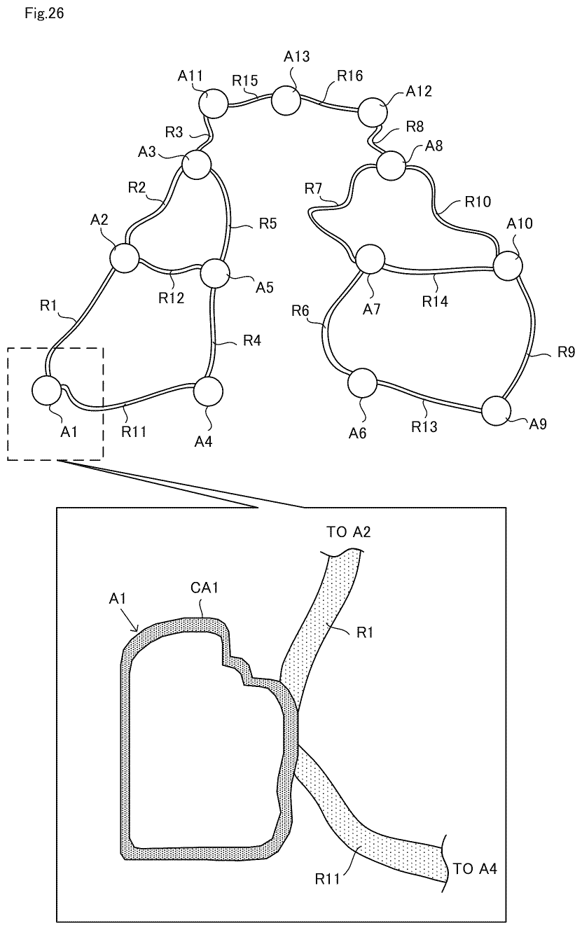

FIG. 26 is a diagram showing an example of a course that is set in the virtual space in the race game of the exemplary embodiment. As shown in FIG. 26, a plurality of base areas A1 to A13 are set in the virtual space. Courses where mobile objects can run in the race game include circuit courses set in the base areas (e.g., the circuit course CA1 set in the base area A1), and connecting courses R1 to R16 that connect between the base areas. A circuit course is a loop-shaped course where mobile objects can run around. On the other hand, a connecting course is a course that connects a circuit course in one base area to another circuit course in another base area. As will be described in detail below, in the race game, a race is held in which mobile objects run some of the courses. In the exemplary embodiment, the courses in the virtual space are all connected.

In the exemplary embodiment, the race game combines together circuit courses and connecting courses. For example, a combined race includes a first race in which mobile objects run two laps of the circuit course CA1 in the base area A1, and then run the connecting course R1 to reach the goal, which is set at a predetermined location in the base area A2, and a second race in which mobile objects run one lap of the circuit course CA2 in the base area A2, then run the connecting course R2, and then runs two laps of the circuit course CA3 in the base area A3 to reach the goal, which is set at a predetermined location in the circuit course CA3. Thus, the exemplary embodiment provides a novel race game in which multiple base areas and connecting courses in the virtual space are used as one continuous course. It should be noted that depending on the race, there may be races that use only the circuit course in a base area or races that use only a connecting course. In a race in which the player object runs a circuit course and a connecting course, “one lap of the circuit course” is not limited to one in which the player object runs strictly the entire circuit course, but may also include one in which the player object runs a portion of the circuit course.

It should be noted that in other embodiments, a course in a conventional race game may be used. That is, a plurality of courses (which may be circuit courses or non-circuit courses) may be set up each in an independent virtual space, and a race game may be played on a single selected course.

It should be noted that in a race game in which the player object runs a course including a connecting course, the game system 1 may display an image indicating a goal point. The image indicating the goal point may be, for example, a landmark object placed at the goal point or a special effect image representing a beam of light shooting upward at the goal point. Then, the game image during a race game will include an image indicating the goal point when the virtual camera for generating the game image is facing toward the goal point. This allows the player to know the direction of the goal point even where the player object is far from the goal point.

Here, for a circuit course, it is easy to arrange many corners in the course because the course is basically designed so that the player object returns to the starting point within a relatively small area. Therefore, the player can cause the player object to perform a drift run through corners in many situations, thus providing the player with the fun of controlling the player object to perform drift runs and turbo runs following drift runs.

In contrast, it can be said that it is more difficult to arrange many corners in a connecting course than in a circuit course because, unlike a loop-shaped circuit course, the start and goal positions are far apart. For example, if many corners were to be arranged on a connecting course, the player object would spend more time running in a direction different from toward the goal point, which may cause the player to feel uncertain about whether the player is moving toward the goal point and to feel awkward about the moving direction. Therefore, in order to make the connecting course natural, the connecting course will include many straight sections. Therefore, on a connecting course, compared to a circuit course, there are fewer chances for the player object to perform drift runs, making it difficult to provide the player with the fun of controlling the player object to perform drift runs and turbo runs following drift runs. In contrast, in the exemplary embodiment, where the player object is allowed to perform a power-charge run, the player object can perform power-charge runs and turbo runs following power-charge runs. Therefore, in connecting courses, it is possible to provide the player with the fun of controlling the player object to perform power-charge runs and turbo runs following power-charge runs, thereby improving the playability of connecting courses. Needless to say, it is possible to provide playability of performing power-charge runs and turbo runs following power-charge runs also in circuit courses. As described above, in the exemplary embodiment, by enabling power-charge runs, it is possible to improve the playability even in a race game using connecting courses, which tend to have many straight sections. Thus, for example, it is possible to improve the playability when executing a race game using a course that has different starting and finishing points in a vast virtual space. Alternatively, it is possible to execute a race game with good playability using the entirety of a vast virtual space. In the exemplary embodiment, since circuit courses and connecting courses are both used in one race, there are both situations in one race where drift runs are advantageous and where power-charge runs are advantageous, thereby improving the playability. It should be noted that a plurality of races may include races that use only one of a circuit course and a connecting course.

In the exemplary embodiment, the game system 1 executes, in addition to the race game described above, a game in which the player object can run freely in the virtual space. In other words, in the exemplary embodiment, the game system 1 includes a game of the first mode (i.e., a race game) in which one or more mobile objects participating in the race game (including the player object) race by running in a predetermined moving direction on a predetermined course in the virtual space, and a game of the second mode in which the player object can run in the virtual space, regardless of the predetermined course. For example, the game system 1 accepts, before the game starts, an input from the player that specifies whether to play a game of the first mode or a game of the second mode, and executes the game in the mode specified by the player.

In a game of the second mode, the course and the moving direction are not defined, and the player can have the player object run freely in the virtual space without competing for position or time. For example, in a game of the second mode, the player object can run not only on the course in a game of the first mode, but also in areas outside the course. It should be noted that areas outside the course are areas where the player object is forced to return to the course or is penalized if the player object enters during a game in the first mode. Thus, the player can play a game of the second mode for the purpose of exploring the virtual space or practicing for a game of the first mode, for example. It should be noted that also in the second mode, the player may be given a task, for example, to run a predetermined course in a predetermined time.

In the exemplary embodiment, runnable object described above are provided not only in areas where the player object can run in a game of the first mode, but also in areas where the player object can run in a game of the second mode. Therefore, in a game of the first mode, the player can have the player object run while using runnable objects to run faster in order to improve position and time. In a game of the second mode, the player can enjoy the fun of discovering new paths using runnable objects, such as paths for jumping from one runnable object to another, for example. Thus, in the exemplary embodiment, it is possible to improve the playability of the game using runnable objects in games of both modes.

In other embodiments, the game system 1 may only execute either games in the first mode or games in the second mode. For example, games executed by the game system 1 may be only games of the second mode and not include a race game. Runnable objects described above may be set only in games of the first mode, or only in games of the second mode. The game system 1 may be capable of executing other types of games different from games of the first mode and games of the second mode.

### [3. Specific Examples of Processes in Game System]

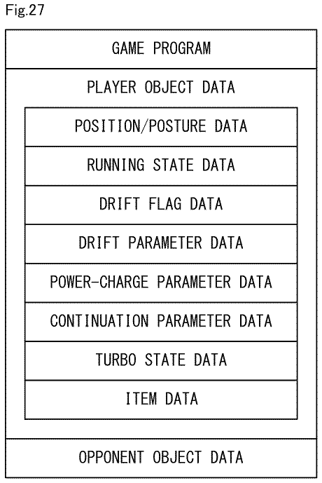

Next, specific examples of information processes in the game system 1 will be described with reference to FIG. 27 to FIG. 36.

FIG. 27 is a diagram showing an example of various data used in information processes in the game system 1. The various data shown in FIG. 27 are stored in a storage medium accessible by the main body apparatus 2 (e.g., the flash memory 84, the DRAM 85, and/or a memory card installed in the slot 23, etc.).

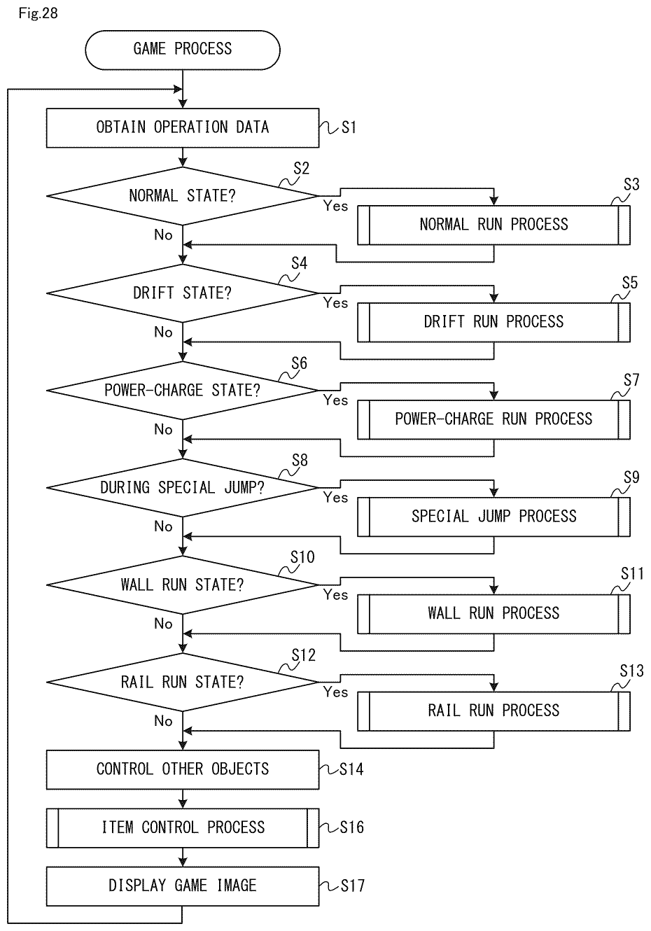

As shown in FIG. 27, the game system 1 stores a game program. The game program is a game program for executing game processes in the exemplary embodiment (specifically, processes shown in FIG. 28 to FIG. 36).

The game system 1 also stores player object data and opponent object data as game process data generated and used in game processes. These data are stored in a memory (e.g., the DRAM 85) used for game processes. These data are stored in the memory at an appropriate timing after the game is started and are updated as the game progresses.

The player object data indicates information about the player object. Specifically, the player object data includes position/attitude data, running state data, drift flag data, drift parameter data, power-charge parameter data, continuation parameter data, turbo state data, and item data.

The position/attitude data indicates the position and attitude of the player object in the virtual space. The running state data indicates the current running state of the player object.

The drift flag data indicates whether the player object will be in the drift state after a normal jump. That is, if the player object is to enter the drift state after a normal jump, the drift flag is set to ON, and if not, the drift flag is set to OFF.

The drift parameter data indicates the drift parameter described above. The power-charge parameter data indicates the power-charge parameter described above. The continuation parameter data indicates the duration since the start of an object run.

The turbo state data indicates a state regarding a turbo run of the player object. Specifically, the turbo state data indicates whether the player object is in the turbo-enabled state, the turbo state, or neither. The turbo state data further indicates the stage of turbo if the player object is in the turbo-enabled state or the turbo state.

The item data indicates information regarding items available to the player object. Specifically, the item data indicates the types of items that can be used by the player object. If an item is in the virtual space as a result of being used, the item data indicates the position and attitude of the item in the virtual space.

The opponent object data indicates information regarding opponent objects. The opponent object data is stored for each opponent object participating in the race game. The opponent object data includes data regarding opponent objects similar to the various data stored for the player object as the player object data.

FIG. 28 is a flowchart showing an example of a flow of the game process executed by the game system 1. The game process shown in FIG. 28 is started, for example, in response to a game being started by an instruction from the player. It should be noted that the game process shown in FIG. 28 mainly shows processes related to the control of various objects (i.e., the player object, opponent objects, and item objects) that appear in the game, and this game process is executed both in a game of the first mode and a game of the second mode described above.

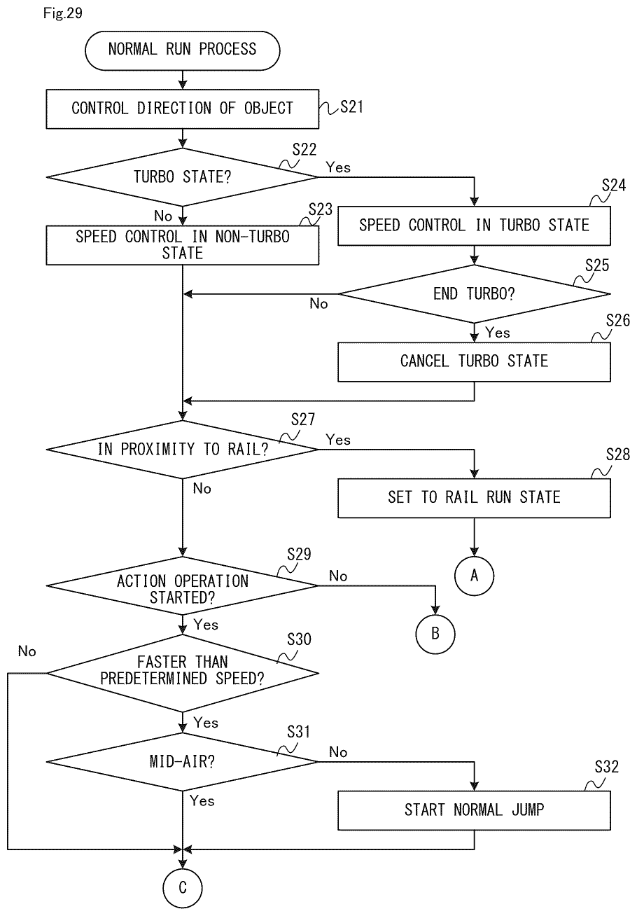

It should be noted that in the exemplary embodiment, the processor 81 of the main body apparatus 2 is described as executing processes of various steps shown in FIG. 28 discussed above and FIG. 29 to FIG. 36 to be discussed below by executing the game program stored in the game system 1. However, in other embodiments, some of the processes of these steps may be executed by another processor (e.g., a dedicated circuit) different from the processor 81. If the game system 1 is capable of communicating with other information processing devices (e.g., servers), some of the processes of the steps shown in FIG. 28 to FIG. 36 may be executed by other information processing devices. The processes of the steps shown in FIG. 28 to FIG. 36 are merely illustrative, and the order of steps to be performed may be switched around or other processes may be executed in addition to (or instead of) the processes of the steps, as long as similar results are obtained.

The processor 81 executes the processes of the steps shown in FIG. 28 to FIG. 36 using a memory (e.g., the DRAM 85). That is, the processor 81 stores the information (in other words, data) obtained in each process step in the memory, and when the information is used in a subsequent process step, the information is read out from the memory and used.

In step S1 shown in FIG. 28, the processor 81 acquires the operation data indicating an instruction by the player. That is, the processor 81 acquires operation data received from each controller via the controller communication section 83 and/or the terminals 17 and 21. The process of step S2 is executed, following step S1.

In step S2, the processor 81 determines whether the player object is in the normal state based on the running state data stored in the memory. It should be noted that in the exemplary embodiment, it is assumed that the running state data is set to indicate the normal state at the start of the game process. If the determination result from step S2 is affirmative, the process of step S3 is executed. On the other hand, if the determination result from step S2 is negative, the process of step S4 to be described below is executed.

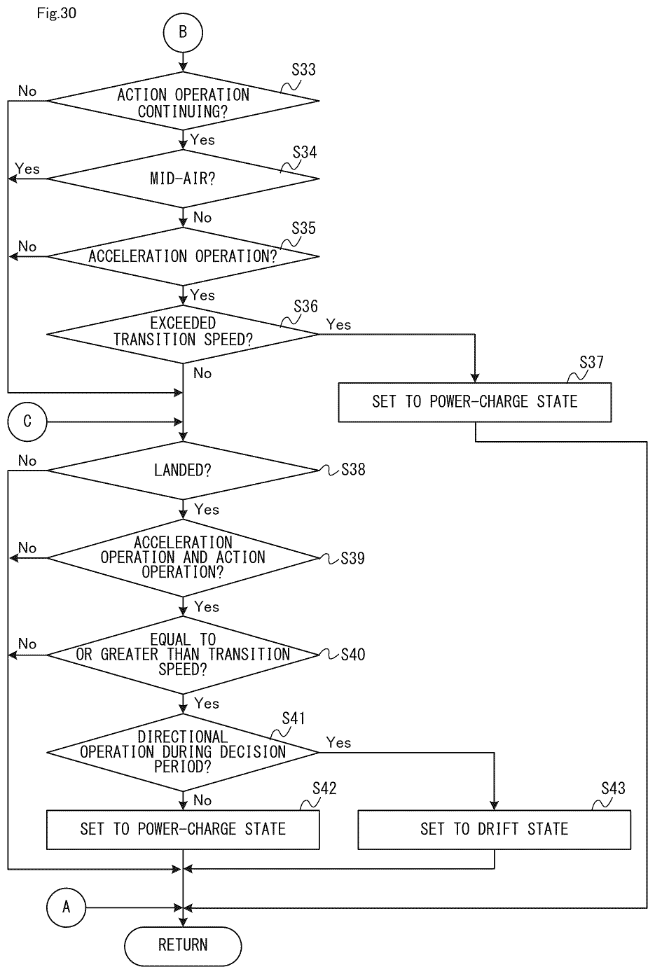

In step S3, the processor 81 executes the normal run process. The normal run process is a process of controlling the action of the player object in the normal state. Referring to FIG. 29 and FIG. 30, the details of the normal run process will be described below.

FIG. 29 and FIG. 30 are sub-flowcharts each showing an example of a detailed flow of the normal run process of step S3 shown in FIG. 28. In the normal run process, first, in step S21, the processor 81 controls the direction of the player object based on the directional operation input by the player. Specifically, the processor 81 refers to the operation data acquired in step S1 and determines the moving direction of the player object in accordance with the directional operation input in the left-right direction. The specific method of determining the moving direction of the player object is arbitrary. For example, the moving direction is determined so that the player object changes the moving direction left and right by an amount corresponding to the left-right tilt of the analog stick 32. It should be noted that the player object may be mid-air, for example, by performing a normal jump action, falling from a wall object, or jumping out from a step in the course. In such a case, the moving direction is determined while considering the speed at which the player object runs off the wall object or the course and the effects of gravity, etc. The process of step S22 is executed, following step S21.

In step S22, the processor 81 determines whether the player object is in the turbo state. It should be noted that it is assumed that the player object is not in the turbo state at the start of the game process. If the determination result from step S22 is negative, the process of step S23 is executed. On the other hand, if the determination result from step S22 is affirmative, the process of step S24 is executed.

In step S23, the processor 81 controls the speed of the player object by a control method for the case where the player object is not in the turbo state. That is, the processor 81 determines the speed of the player object based on the acceleration operation input by the player. The specific method of determining the speed of the player object is arbitrary. For example, when an acceleration operation input is being made, the speed of the player object is determined to increase from the previous speed (i.e., the speed determined one frame ago), with the maximum speed of the player object while not in the turbo state as the upper limit. For example, when no acceleration operation input is being made, the speed of the player object is determined to decrease from the previous speed. For example, when a brake operation input is being made, the speed of the player object is determined to decrease from the previous speed, and by a greater amount compared with when no acceleration operation input is being made.

The moving direction and speed determined by the processes of steps S21 and S23 will determine the position and attitude of the player object after moving from the previous position. Therefore, in step S23, the processor 81 calculates the position and attitude of the player object after moving based on the current position and attitude of the player object, as indicated by the position/attitude data stored in the memory, and the moving direction and the speed. The position/attitude data stored in memory is updated to reflect this calculation. The process of step S27 to be described below is executed, following step S23.

In step S24, the processor 81 controls the speed of the player object by the control method in the turbo state. That is, the processor 81 determines the speed of the player object to increase from the previous speed if the previous speed of the player object (i.e., the speed calculated one frame ago) is not the turbo speed described above. If the previous speed of the player object has reached the turbo speed described above, the processor 81 determines the speed of the player object to maintain the previous speed. In step S24, as in step S23, the processor 81 calculates the position and attitude of the player object after moving based on the current position and attitude of the player object as indicated by the position/attitude data stored in the memory, the moving direction determined in step S21, and the speed determined. The position/attitude data stored in the memory is updated to reflect this calculation. The process of step S25 is executed, following step S24.

In step S25, the processor 81 determines whether or not to end the turbo state of the player object. Specifically, the processor 81 refers to the turbo state data stored in the memory and determines whether the duration of the turbo state has reached the turbo limit time corresponding to the stage of turbo indicated by the turbo state data. If the determination result from step S25 is affirmative, the process of step S26 is executed. On the other hand, if the determination result from step S25 is negative, the process of step S27 is executed.

In step S26, the processor 81 cancels the turbo state of the player object. That is, the processor 81 updates the turbo state data stored in the memory so that the data indicates the non-turbo state. The process of step S27 is executed, following step S26.

In step S27, the processor 81 determines whether the player object has come in proximity to a rail object. Specifically, based on the position/attitude data stored in the memory, the processor 81 determines whether the distance between the player object and the rail object has become less than or equal to a predetermined value. If the determination result from step S27 is affirmative, the process of step S28 is executed. On the other hand, if the determination result from step S27 is negative, the process of step S29 is executed.

In step S28, the processor 81 sets the running state of the player object to the rail run state. That is, the processor 81 updates the running state data stored in the memory so that the data indicates the rail run state. Therefore, when the process loop of steps S1 to S17 is executed next, the rail run process (step S13) will be executed. The processor 81 ends the normal run process, following step S28.

In step S29, the processor 81 determines whether an action operation input by the player has been started. That is, the processor 81 refers to the operation data acquired in step S1 and determines whether the action operation input, which was not made in the previous iteration of the process loop of S1 to S17, has been started in the current iteration of the process loop. If the determination result from step S29 is affirmative, the process of step S30 is executed. On the other hand, if the determination result from step S29 is negative, the process of step S33 shown in FIG. 30 is executed.

In step S30, the processor 81 determines whether the speed of the player object is faster than a predetermined speed based on the result of the process of step S23 or S24. This predetermined speed is a speed at which the player object can perform a normal jump, and is set to a value less than the transition speed. If the determination result from step S30 is affirmative, the process of step S31 is executed. On the other hand, if the determination result from step S30 is negative, the process of step S38 shown in FIG. 30 is executed.

In step S31, the processor 81 determines whether the player object is mid-air based on the position/attitude data stored in the memory. If the determination result from step S31 is negative, the process of step S32 is executed. On the other hand, if the determination result from step S31 is affirmative, the process of step S38 shown in FIG. 30 is executed.

In step S32, the processor 81 causes the player object to start a normal jump action. After the player character starts a normal jump action in step S32, the player object is controlled to perform a normal jump action over a certain period of time by the process of step S21. Thus, in the exemplary embodiment, the player object performs a normal jump in response to an action operation input being made while the player object in the normal state is running on the ground at a speed higher than the predetermined speed. The process of step S38 shown in FIG. 30 is executed, following step S32.

In step S33 shown in FIG. 30, the processor 81 determines whether or not an action operation input is continuing. That is, the processor 81 refers to the operation data acquired in step S1 and determines whether an action operation input, which was being made in the previous iteration of the process loop of S1 to S17, is continuing in the current iteration of the process loop. If the determination result from step S33 is affirmative, the process of step S34 is executed. On the other hand, if the determination result from step S33 is negative, the process of step S38 is executed.

In step S34, the processor 81 determines whether the player object is mid-air based on the position/attitude data stored in the memory. If the determination result from step S34 is negative, the process of step S35 is executed. On the other hand, if the determination result from step S34 is affirmative, the process of step S38 is executed.

In step S35, the processor 81 refers to the operation data acquired in step S1 and determines whether an acceleration operation input is made. If the determination result from step S35 is affirmative, the process of step S36 is executed. On the other hand, if the determination result from step S35 is negative, the process of step S38 is executed.

In step S36, the processor 81 determines whether the speed of the player object has exceeded the transition speed. That is, the processor 81 determines whether the speed of the player object calculated in the previous iteration of the process loop of S1 to S17 is less than or equal to the transition speed and the speed calculated in the current iteration of the process of step S23 or S24 has become higher than the transition speed. If the determination result from step S36 is affirmative, the process of step S37 is executed. On the other hand, if the determination result from step S36 is negative, the process of step S38 is executed.

In step S37, the processor 81 sets the running state of the player object to the power-charge state. That is, the processor 81 updates the running state data stored in the memory so that the data indicates the power-charge state. As described above, the second power-charge condition described above is determined by the processes of steps S33 to S36, and if the second power-charge condition is satisfied, the player object is set to the power-charge state by the process of step S37. The processor 81 ends the normal run process, following step S37.

In step S38, the processor 81 determines whether the player object has landed. If the determination result from step S38 is affirmative, the process of step S39 is executed. On the other hand, if the determination result from step S38 is negative, the processor 81 ends the normal run process.

In step S39, the processor 81 refers to the operation data acquired in step S1 and determines whether an acceleration operation input and an action operation input are made. If the determination result from step S39 is affirmative, the process of step S40 is executed. On the other hand, if the determination result from step S39 is negative, the processor 81 ends the normal run process.

In step S40, the processor 81 determines whether the speed of the player object is faster than the transition speed based on the result of the process of step S23 or S24. If the determination result from step S40 is affirmative, the process of step S41 is executed. On the other hand, if the determination result from step S40 is negative, the processor 81 ends the normal run process.

In step S41, the processor 81 refers to the operation data acquired in step S1 and determines whether a directional operation input is made during the decision period. If the determination result from step S41 is affirmative, the process of step S42 is executed. On the other hand, if the determination result from step S41 is negative, the process of step S43 is executed.

In step S42, the processor 81 sets the running state of the player object to the power-charge state, as in step S37. The processor 81 ends the normal run process, following step S42.

In step S43, the processor 81 sets the running state of the player object to the drift state. That is, the processor 81 updates the running state data stored in the memory so that the data indicates the drift state. The processor 81 ends the normal run process, following step S42. The process of step S4 is executed, following the normal run process.

As described above, in steps S38 to S41 described above, the process determines the first power-charge condition and the drift condition, and if the first power-charge condition is satisfied, the player object is set to the power-charge state by the process of step S42, and if the drift condition is satisfied, the player object is set to the drift state by the process of step S43.

Referring back to FIG. 28, in step S4, the processor 81 determines whether the player object is in the drift state based on the running state data stored in the memory. If the determination result from step S4 is affirmative, the process of step S5 is executed. On the other hand, if the determination result from step S4 is negative, the process of step S6 to be described below is executed.

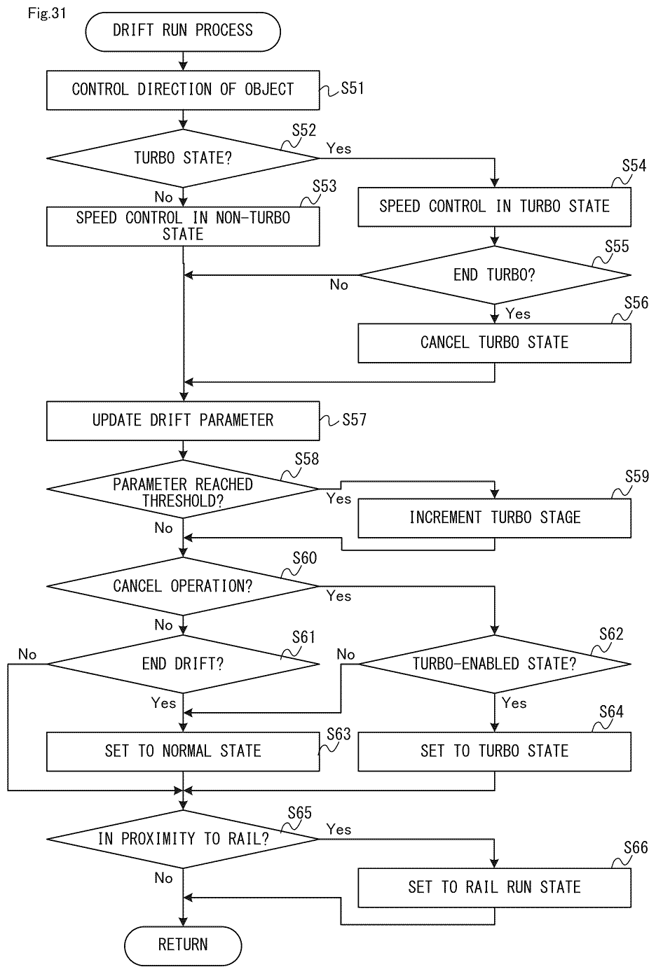

In step S5, the processor 81 executes the drift run process. The drift run process is a process of controlling the action of the player object in the drift state. Referring to FIG. 31, the details of the drift run process will be described below.

FIG. 31 is a sub-flowchart showing an example of a detailed flow of the drift run process of step S5 shown in FIG. 28. In the drift run process, first, in step S51, the processor 81 controls the direction of the player object based on the directional operation input by the player. Specifically, the processor 81 refers to the operation data acquired in step S1 and determines the moving direction of the player object in accordance with the directional operation input in the left-right direction. As described in “[2-1. Drift state]” above, the processor 81 determines the moving direction so that the player object swings out wide in the direction opposite to the direction of the turn in the beginning of the turn and then the player object turns with a smaller turning radius than in the normal state after passage of a predetermined amount of time since the start of the turn. The process of step S52 is executed, following step S51.

The series of processes of steps S52 to S56 is similar to those of steps S22 to S26 in the normal run process.

In step S57, the processor 81 updates the drift parameter. Specifically, the processor 81 counts the duration since the start of the drift state, and updates the drift parameter data stored in the memory so that the data indicates the duration. The process of step S58 is executed, following step S57.

In step S58, the processor 81 determines whether the drift parameter has become equal to a predetermined threshold value. Here, the threshold values include the first threshold value for setting the turbo stage to the first stage, the second threshold value for setting the turbo stage to the second stage, and the third threshold value for setting the turbo stage to the third stage. The processor 81 determines whether the drift parameter has become equal to one of the first to third threshold values. If the determination result from step S58 is affirmative, the process of step S59 is executed. On the other hand, if the determination result from step S58 is negative, the process of step S60 is executed.

In step S59, the processor 81 increments the turbo stage by one. The processor 81 updates the turbo state data stored in the memory so that the data indicates the turbo-enabled state and indicates the turbo stage that is set. The process of step S60 is executed, following step S59.

In step S60, the processor 81 determines whether an operation input to cancel the drift state has been performed. Specifically, the processor 81 refers to the operation data acquired in step S1 and determines whether an action operation input (i.e., pressing of the first R-button 60), which was made at the start of the drift state, has been ended. If the determination result from step S60 is affirmative, the process of step S61 is executed. On the other hand, if the determination result from step S60 is negative, the process of step S62 is executed.

In step S61, the processor 81 determines whether or not to end the drift state of the player object. Specifically, the processor 81 refers to the operation data acquired in step S1 and determines whether an acceleration operation input has been discontinued. If the determination result from step S61 is affirmative, the process of step S63 is executed. On the other hand, if the determination result from step S61 is negative, the process of step S63 is executed.

In step S62, the processor 81 refers to the turbo state data stored in the memory and determines whether the player object is in the turbo-enabled state. If the determination result from step S62 is negative, the process of step S63 is executed. On the other hand, if the determination result from step S62 is affirmative, the process of step S64 is executed.

In step S63, the processor 81 sets the running state of the player object to the normal state. That is, the processor 81 updates the running state data stored in the memory so that the data indicates the normal state. Therefore, when the process loop of steps S1 to S17 is executed next, the normal run process (step S3) will be executed. The process of step S65 is executed, following step S63.

In step S64, the processor 81 sets the player object to the turbo state. That is, the processor 81 updates the turbo state data stored in the memory so that the data indicates the turbo state and indicates the turbo stage that is set in step S59. The process of step S65 is executed, following step S64.

The processes of steps S65 and S66 are similar to those of steps S27 and S28 in the normal run process. The processor 81 ends the drift run process if it is determined in step S65 that the player object is not in proximity to a rail object, or after completion of step S66. The process of step S6 is executed, following the drift run process.

Referring back to FIG. 28, in step S6, the processor 81 determines whether the player object is in the power-charge state based on the running state data stored in the memory. If the determination result from step S6 is affirmative, the process of step S7 is executed. On the other hand, if the determination result from step S6 is negative, the process of step S8 to be described below is executed.

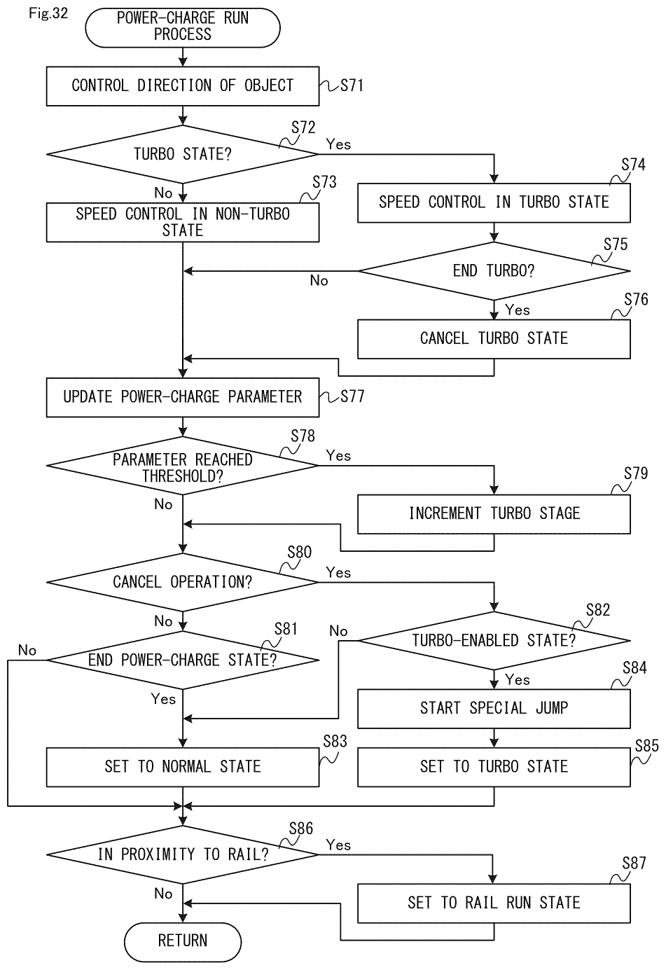

In step S7, the processor 81 executes the power-charge run process. The power-charge run process is a process of controlling the action of the player object in the power-charge state. Referring to FIG. 32, the details of the power-charge run process will be described below.

FIG. 32 is a sub-flowchart showing an example of a detailed flow of the power-charge run process of step S7 shown in FIG. 28. In the power-charge run process, first, in step S71, the processor 81 controls the direction of the player object based on the directional operation input by the player. Specifically, the processor 81 refers to the operation data acquired in step S1 and determines the moving direction of the player object in accordance with the directional operation input in the left-right direction. As described in “[2-2. Power-charge state]” above, the processor 81 determines the moving direction so that it is more difficult to turn than in the normal state. The process of step S72 is executed, following step S71.

The series of processes of steps S72 to S76 is similar to those of steps S22 to S26 in the normal run process.

In step S77, the processor 81 updates the power-charge parameter. Specifically, the processor 81 counts the duration since the start of the power-charge state, and updates the power-charge parameter data stored in the memory so that the data indicates the duration. The process of step S78 is executed, following step S77.

In step S78, the processor 81 determines whether the power-charge parameter has become equal to a predetermined threshold value. Here, as in the process of step S58, the threshold values used in the determination in step S78 include the first threshold value for setting the turbo stage to the first stage, the second threshold value for setting the turbo stage to the second stage, and the third threshold value for setting the turbo stage to the third stage. However, the specific values of the first to third threshold values may differ between step S58 and step S78. The processor 81 determines whether the power-charge parameter has become equal to one of the first to third threshold values. If the determination result from step S78 is affirmative, the process of step S79 is executed. On the other hand, if the determination result from step S78 is negative, the process of step S80 is executed.

In step S79, the processor 81 increments the turbo stage by one. The process of step S79 is similar to that of step S59. The process of step S80 is executed, following step S79.

In step S80, the processor 81 determines whether an operation input to cancel the power-charge state has been performed. Specifically, the processor 81 refers to the operation data acquired in step S1 and determines whether an action operation input (i.e., pressing of the first R-button 60), which was made at the start of the power-charge state, has been ended. If the determination result from step S80 is affirmative, the process of step S81 is executed. On the other hand, if the determination result from step S80 is negative, the process of step S82 is executed.

In step S81, the processor 81 determines whether or not to end the power-charge state of the player object. For example, the processor 81 refers to the operation data acquired in step S1 and determines whether an acceleration operation input has been discontinued. If the determination result from step S81 is affirmative, the process of step S83 is executed. On the other hand, if the determination result from step S81 is negative, the process of step S86 to be described below is executed.

In step S82, the processor 81 refers to the turbo state data stored in the memory and determines whether the player object is in the turbo-enabled state. If the determination result from step S82 is negative, the process of step S83 is executed. On the other hand, if the determination result from step S82 is affirmative, the process of step S84 is executed.

In step S83, the processor 81 sets the running state of the player object to the normal state, as in step S63. The process of step S86 is executed, following step S83.

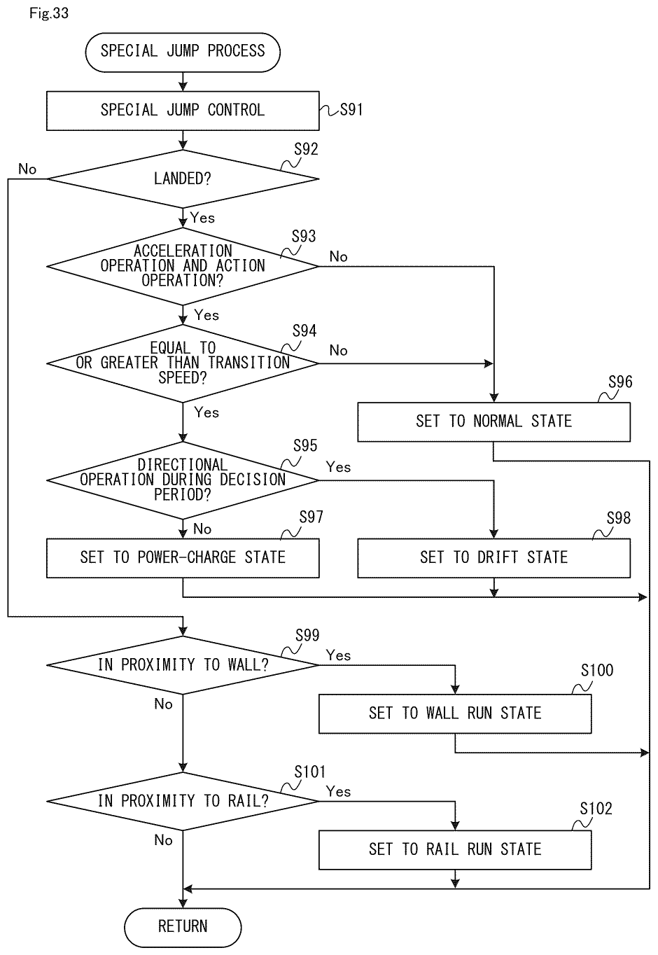

In step S84, the processor 81 causes the player object to start a special jump action. It should be noted that at this time, the processor 81 updates the running state data stored in the memory so that the data indicates the state during the special jump. After the player character has started a special jump action in step S84, the player object is controlled to perform a special jump action over a certain period of time by the special jump process (FIG. 33) in step S9 to be described below. The process of step S85 is executed, following step S84.

In step S85, the processor 81 sets the player object to the turbo state. That is, the processor 81 updates the turbo state data stored in the memory so that the data indicates the turbo state and indicates the turbo stage that is set in step S79. The process of step S86 is executed, following step S85.

The processes of steps S86 and S87 are similar to those of steps S27 and S28 in the normal run process. The processor 81 ends the power-charge run process if it is determined in step S86 that the player object is not in proximity to a rail object, or after completion of step S87. The process of step S8 is executed, following the power-charge run process.

Referring back to FIG. 28, in step S8, the processor 81 determines whether the player object is during a special jump based on the running state data stored in the memory. If the determination result from step S8 is affirmative, the process of step S9 is executed. On the other hand, if the determination result from step S8 is negative, the process of step S10 to be described below is executed.

In step S9, the processor 81 executes the special jump process. The special jump process is a process of controlling the action of the player object during a special jump. Referring to FIG. 33, the details of the special jump process will be described below.

FIG. 33 is a sub-flowchart showing an example of a detailed flow of the special jump process of step S9 shown in FIG. 28. In the special jump process, first, in step S91, the processor 81 controls the player object to perform the action of a special jump. That is, the player object is controlled to perform a series of actions from the start to landing of a special jump. It should be noted that the processor 81 controls the player object to perform an action for one frame time in one iteration of the process of step S91. The player object performs a series of actions of a special jump by repeating the process of step S91 over a plurality of frames. The process of step S92 is executed, following step S91.

The series of processes of steps S92 to S95 is similar to those of steps S38 to S41 in the normal run process. It should be noted that in the special jump process, if the determination result from step S92 is negative, the process of step S99 is executed. If the determination result from step S93 or step S94 is negative, the process of step S96 is executed. If the determination result from step S95 is negative, the process of step S97 is executed. If the determination result from step S95 is affirmative, the process of step S99 is executed.

In step S96, the processor 81 sets the running state of the player object to the normal state, as in the process of step S63. The processor 81 ends the special jump process, following step S96.

In step S97, the processor 81 sets the running state of the player object to the drift state, as in the process of step S43. The processor 81 ends the special jump process, following step S97.

In step S98, the processor 81 sets the running state of the player object to the power-charge state, as in the process of step S37. The processor 81 ends the special jump process, following step S98.

As described above, in steps S92 to S95, the first power-charge condition and the drift condition described above are determined, and if the first power-charge condition is satisfied, the player object is set to the power-charge state by the process of step S97, and if the drift condition is satisfied, the player object is set to the drift state by the process of step S98. If neither the first power-charge condition nor the drift condition is satisfied at the time of landing of the player object, the player object is set to the normal state by the process of step S96.

In step S99, the processor 81 determines whether the player object has come in proximity to a wall object. Specifically, the processor 81 determines whether the distance between the player object and the wall object has become less than or equal to a predetermined value based on the position/attitude data stored in the memory. If the determination result from step S99 is affirmative, the process of step S100 is executed. On the other hand, if the determination result from step S99 is negative, the process of step S101 is executed.

In step S100, the processor 81 sets the running state of the player object to the wall run state. That is, the processor 81 updates the running state data stored in the memory so that the data indicates the wall run state. Therefore, when the process loop of steps S1 to S17 is executed next, the wall run process (step S11) will be executed. The processor 81 updates the turbo state data stored in the memory so that the data indicates the turbo-enabled state. The processor 81 ends the special jump process, following step S100.

In step S101, the processor 81 determines whether the player object has come in proximity to a rail object. The process of step S101 is similar to that of step S27 in the normal run process. If the determination result from step S101 is affirmative, the process of step S102 is executed. On the other hand, if the determination result from step S101 is negative, the processor 81 ends the special jump process.

In step S102, the processor 81 sets the running state of the player object to the rail run state. The process of step S97 is similar to that of step S28 in the normal run process. Therefore, when the process loop of steps S1 to S17 is executed next, the rail run process (step S13) will be executed. The processor 81 updates the turbo state data stored in the memory so that the data indicates the turbo-enabled state. The processor 81 ends the special jump process, following step S102. The process of step S10 is executed, following the special jump process.

Referring back to FIG. 28, in step S10, the processor 81 determines whether the player object is in the wall run state based on the running state data stored in the memory. If the determination result from step S10 is affirmative, the process of step S11 is executed. On the other hand, if the determination result from step S10 is negative, the process of step S12 to be described below is executed.

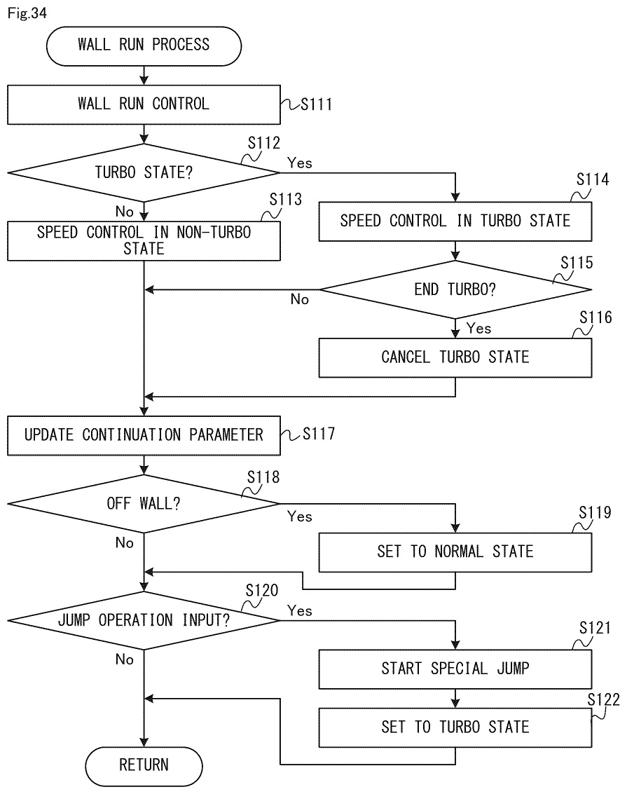

In step S10, the processor 81 executes the wall run process. The wall run process is a process of controlling the action of the player object in the wall run state. Referring to FIG. 34, the details of the wall run process will be described below.

FIG. 34 is a sub-flowchart showing an example of a detailed flow of the wall run process of step S10 shown in FIG. 28. In the wall run process, first, in step S111, the processor 81 controls the direction of the player object so that the player object runs on a wall object. Specifically, as described in “[2-3. Object run state]” above, the player object is controlled to run along the wall surface of the wall object. That is, the moving direction of the player object is determined to be a direction along the wall surface of the wall object. The process of step S112 is executed, following step S111.

The series of processes of steps S112 to S116 is similar to those of steps S22 to S26 in the normal run process.

In step S117, the processor 81 updates the continuation parameter. Specifically, the processor 81 counts the duration since the start of the wall run state, and updates the continuation parameter data stored in the memory so that the data indicates the duration. The process of step S118 is executed, following step S117.

In step S118, the processor 81 determines whether or not to cause the player object running on the wall object to run off the wall object. Specifically, the processor 81 determines whether the duration of the wall run has reached the wall run limit time described above. If the determination result from step S118 is affirmative, the process of step S119 is executed. On the other hand, if the determination result from step S118 is negative, the process of step S120 is executed.

In step S119, the processor 81 sets the running state of the player object to the normal state, as in step S63. Therefore, when the process loop of steps S1 to S17 is executed next, the normal run process (step S3) will be executed and the player object will be controlled to run off the wall object and run on the course. The process of step S120 is executed, following step S119.

In step S120, the processor 81 refers to the operation data acquired in step S1 and determines whether an action operation input is made by the player. If the determination result from step S120 is affirmative, the process of step S121 is executed. On the other hand, if the determination result from step S120 is negative, the processor 81 ends the wall run process.

In step S121, the processor 81 causes the player object to start the action of a special jump. The process of step S121 is similar to that of step S84 in the power-charge run process. The process of step S122 is executed, following step S121.

In step S122, the processor 81 sets the player object to the turbo state. That is, the processor 81 updates the turbo state data stored in the memory so that the data indicates the turbo state. The processor 81 ends the wall run process, following step S122. The process of step S12 is executed, following the wall run process.

Referring back to FIG. 28, in step S12, the processor 81 determines whether the player object is in the rail run state based on the running state data stored in the memory. If the determination result from step S12 is affirmative, the process of step S13 is executed. On the other hand, if the determination result from step S12 is negative, the process of step S14 to be described below is executed.

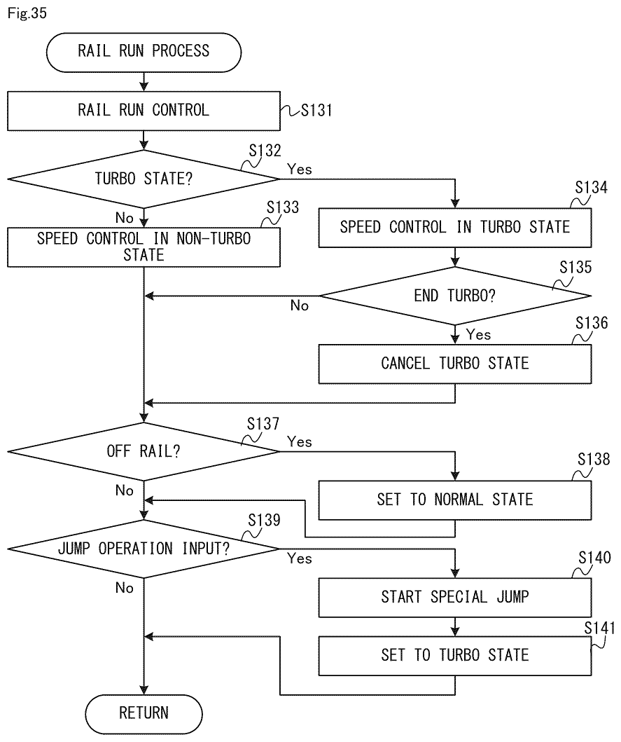

In step S13, the processor 81 executes the rail run process. The rail run process is a process of controlling the action of the player object in the rail run state. Referring to FIG. 35, the details of the rail run process will be described below.

FIG. 35 is a sub-flowchart showing an example of a detailed flow of the rail run process of step S13 shown in FIG. 28. In the rail run process, first, in step S131, the processor 81 controls the direction of the player object so that the player object runs on a rail object. Specifically, as described in “[2-3. Object run state]” above, the player object is controlled to run along the rail object. That is, the moving direction of the player object is determined to be a direction along the direction in which the rail object extends. The process of step S132 is executed, following step S131.

The series of processes of steps S132 to S136 is similar to those of steps S22 to S26 in the normal run process.

In step S137, the processor 81 determines whether to cause the player object to run off the rail object on which the player object is running. Specifically, the processor 81 determines whether the player object is located at the end of the rail object, and whether an opponent object has collided with the player object from behind on the rail object. If the player object is located at the end of the rail object or if an opponent object has collided with the player object from behind, the processor 81 determines to cause the player object to run off the rail object on which the player object is running. On the other hand, if the player object is not located at the end of the rail object and if an opponent object has not collided with the player object from behind, the processor 81 determines not to cause the player object to run off the rail object on which the player object is running. If the determination result from step S137 is affirmative, the process of step S138 is executed. On the other hand, if the determination result from step S137 is negative, the process of step S139 is executed.

In step S138, the processor 81 sets the running state of the player object to the normal state, as in step S63. Therefore, when the process loop of steps S1 to S17 is executed next, the normal run process (step S3) will be executed and the player object will be controlled to run off the rail object and run on the course. The process of step S139 is executed, following step S138.

In step S139, the processor 81 refers to the operation data acquired in step S1 and determines whether an action operation input is made by the player. If the determination result from step S139 is affirmative, the process of step S140 is executed. On the other hand, if the determination result from step S139 is negative, the processor 81 ends the rail run process.

In step S140, the processor 81 causes the player object to start a special jump action. The process of step S140 is similar to that of step S84 in the power-charge run process. The process of step S141 is executed, following step S140.

In step S141, the processor 81 sets the player object to the turbo state. That is, the processor 81 updates the turbo state data stored in the memory so that the data indicates the turbo state. The processor 81 ends the rail run process, following step S141. The process of step S14 is executed, following the rail run process.

Referring back to FIG. 28, in step S14, the processor 81 controls the action of another object that appears in the virtual space. Specifically, the processor 81 calculates the position and attitude of the other object after the other object is moved, and controls the action (e.g., an action of spinning) when the other object collides with an attack item. It should be noted that for example, the other object is an opponent object in a game of the first mode described above, and is a car object other than the player object running in the virtual space in a game of the second mode. Where the other object is controlled automatically, the processor 81 controls the action of the other object in accordance with a predetermined algorithm included in the game program. Where the other object is controlled by another player, the processor 81 acquires data indicating an operation by the other player from another game system via the network communication section, and controls the action of the other object based on the acquired data. The process of step S15 is executed, following step S14.

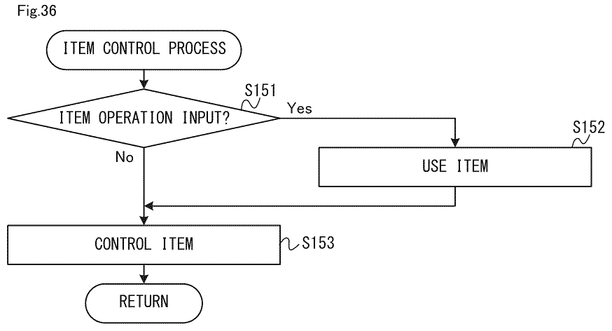

In step S15, the processor 81 executes the item control process. The item control process is a process of controlling the action of an item (here, an attack item) used by the player object. Referring to FIG. 36, the details of the item control process will be described below.

FIG. 36 is a sub-flowchart showing an example of a detailed flow of the item control process of step S15 shown in FIG. 28. In the item control process, first, in step S151, the processor 81 refers to the operation data acquired in step S1 and determines whether an item operation input is made by the player. If the determination result from step S151 is affirmative, the process of step S152 is executed. On the other hand, if the determination result from step S151 is negative, the process of step S153 is executed. It should be noted that an item may be obtained through a predetermined event.

In step S152, the processor 81 causes the player object to perform an action of using an item. For example, where an item to be used is an attack item, the processor 81 causes the attack item to appear in the virtual space. In this case, the processor 81 updates the item data stored in the memory so that the data indicates the position and attitude of the attack item. For an attack item, for which an attack target is set, the processor 81 determines another object to be the attack target at a predetermined timing. It should be noted that the process of step S152 is skipped if the player object does not own an item when step S152 is executed. The process of step S153 is executed, following step S152.

In step S153, the processor 81 controls an action of a fired attack item. As described in “[2-3. Object run state]” above, when fired on a rail object, an attack item is controlled to travel along the rail object. When fired other than on a rail object, or when an attack item travels on a rail object and comes off the end of the rail object, an attack item that tracks an attack target is controlled to travel toward the other object, which is the attack target. It should be noted that in one iteration of the process of step S153, the processor 81 controls the attack item to perform an action of traveling for one frame time. As the process of step S153 is repeated over a plurality of frames, the attack item continues traveling until the attack item collides with the attack target. The processor 81 ends the item control process, following step S153. The process of step S17 is executed, following the item control process.

In step S17, the processor 81 generates a game image representing the virtual space and displays the generated game image on a display device. For example, the processor 81 generates a game image representing the virtual space including the player object based on a virtual camera whose position and direction are controlled to include the player object within its viewing range. It should be noted that the processor 81 generates a game image in such a way that the manner of display varies depending on the various states of the player object. During the game, the process loop of steps S1 to S17 is repeatedly executed at a rate of once per a predetermined amount of time (e.g., one frame time), thus updating the game image, dynamically reflecting the state of the game space. It should be noted that the display device on which the game image is displayed may be the display 12 described above or may be any other display device connected to the main body apparatus 2.

The process of step S1 is executed again, following step S17. Thereafter, the series of processes of steps S1 to S17 is repeatedly executed during the game. It should be noted that the game process shown in FIG. 28 is ended when an instruction to end the game is given by the player, or when a condition for ending the game is satisfied (e.g., one race game has been completed).

### [4. Functions/Effects and Variations of Exemplary Embodiment]

As described above, in the embodiment described above, the game system 1 executes a race game in a virtual space, in which the player object is controlled in response to an operation input by the player. The game system 1 includes the following units:
a first running control unit (step S5) that causes a player object to run in a first running state (a specific example is a drift state) if there is a first operation input (a specific example is an action operation input) at a time of landing on a track path by the player object and if there is a predetermined turn operation input (a specific example is a directional operation input) at a predetermined timing at or before the time of landing;
a second running control unit (step S7) that causes the player object to run in a second running state (a specific example is a power-charge state), which is different from the first running state, if there is a first operation input at the time of landing on a track path by the player object and if there is not a predetermined turn operation input at the predetermined timing; and
a second running control unit (step S24, step S54, step S74, step S114) that causes the player object to temporarily run in a third running state (a specific example is a turbo state), which is advantageous in the race game, based on a parameter that increases in accordance with continuation of the first running state.

With the configuration above, when the player object is running straight in the race game, the player object can advantageously play the race game by performing an operation of transitioning the player object from the second running state to the third running state. Therefore, in the embodiment described above, it is possible to motivate the player to perform operations even when the player object is running straight, thereby improving the playability of operations when the player object is running straight.

The “track path” means to include at least the race course of the race game in the virtual space. The “track path” may include areas of the virtual space that are outside the race track but can be driven by the player object (e.g., a rough terrain off the track).

The “first operation input” may be used, for example, to determine whether to transition the player object to the first running state or the second running state as in the embodiment described above, and also to cause the player object to perform some action (e.g., the normal jump action described above). However, the “first operation input” may be used only for making the determination above (i.e., the player object does not have to perform any action in response to the first operation input). As an example, when the first operation input does not cause the player object to jump, the game system may, instead of determining whether there has been a turn operation input at the predetermined timing at or before landing, determine whether there has been the turn operation input during a predetermined input-accepting period including the point in time when the first operation input was made. If it is determined that there has been the turn operation input during the input-accepting period, the player object is controlled to run in the first running state, and if it is determined that there has not been the turn operation input during the input-accepting period, the player object is controlled to run in the second running state. It should be noted that the input-accepting period may be, for example, a point in time when the first operation input is made, or it may be a period of time including at least before or after the point in time. The game system may cause the player object run in the second running state in response to the first operation input being made, and cause the player object run in the first running state in response to the turn operation input being made during the second running state.

The “predetermined timing” is, for example, a timing within a period of time that includes the time of landing of the player object and the time of being mid-air leading up to the landing. It should be noted that embodiments included in the game program include an embodiment in which only a certain point in time at or before the landing corresponds to the “predetermined timing”, and an embodiment in which a plurality of points in time at or before the landing correspond to the “predetermined timing”. The former embodiment, for example, is an embodiment in which the player object is caused to run in the first running state when there is a turn operation input at the time of landing (it is assumed that there is also a first operation input at this time). The latter embodiment, for example, is an embodiment in which the player object is caused to run in the first running state when there is a turn operation input at any timing during a period from a first point in time to a second point in time, where the second point in time is the time of landing or a point in time prior to the time of landing.

The “first running state” is the drift state in the embodiment described above, but is not limited to this in other embodiments. The first running state may be, for example, a state in which the player object is controlled so that the cornering performance of the player object when turning in the first running state is higher than the cornering performance of the player object when turning in the normal state. For example, the first running state may be a state in which the turning radius is the same as in the normal state and the player object can turn at a faster speed than in the normal state. For example, the first running state may be a state in which the player object can turn sharply disregarding the inertia, or it may be a state in which the player object rotates in place (after which the player object can stop rotating and move forward in response to a predetermined operation input).

It should be noted that the “second running state” in the embodiment described above is a power-charge run state in which the running performance (which can be said to be the method of controlling the player object in response to operation inputs by the player) of the player object is different from that in the normal state, but is not limited to this. The “second running state” may be any state in which the parameter described above increases. The running performance of the player object in the second running state may be the same as that in the normal state, and the manner of display of the player object in the second running state may be the same as that in the normal state.

For example, “causing the player object to run in the third running state based on a parameter” means to include a process in which the player object is caused to run in the third running state on the condition that the parameter reach a predetermined value, or a process in which the player object is caused to run in the third running state for an amount of time in proportion to the parameter. It should be noted that in a case where the player object is caused to run in the third running state on the condition that the parameter reach a predetermined value, as in the embodiment described above, the player is required to perform operations so that the second running state continues for a certain period of time in order to reach the third running state, thereby further improving the strategic aspect of the race game.

In the embodiment described above, when there is a predetermined operation input (e.g., an action operation input) by the player, the game system 1 causes the player object to run in the first running state (e.g., the drift state) if the first condition is satisfied, and causes the player object to run in the second running state (e.g., the power-charge state) if the second condition is satisfied.

Here, the first running state may be, for example, a running state in which the player object is controlled to turn when there is no directional operation input. In this case, the player object in the first running state may be allowed to temporarily run straight by making a directional operation input. The player object in the first running state may be controlled so that the player object cannot run straight permanently, even if the player object can temporarily run straight by making a directional operation input. On the other hand, the second running state may be, for example, a running state in which the player object is controlled to run straight when there is no directional operation input.

The first condition may include a condition that a predetermined directional operation input be made during a predetermined period of time including a point in time at which the predetermined operation input was made (e.g., from a predetermined amount of time before that point in time to that point in time). The second condition may also include a condition that no predetermined directional operation input be made during the predetermined period of time. The first condition and the second condition may both include a condition that the speed of the player object be faster than a predetermined speed. It should be noted that if neither the first condition nor the second condition is satisfied, the player object may be controlled to run in the normal state.

The “predetermined operation input” may be an input that is made continuously. That is, the game system 1 may determine whether the first condition or the second condition is satisfied when there is a predetermined operation input that is made continuously.

In the embodiment described above, it can be said that the game system 1 includes the following elements:
a first running control unit (step S3) that causes a player object to run in a direction in accordance with a directional operation input made by a user when the player object is in a general area in the virtual space;
a second running control unit (step S11, step S13) that, when the player object is on a predetermined object (a specific example is a runnable object) in the virtual space, causes the player object in a direction toward the predetermined object;
a first jump control unit (step S113, step S133) that causes the player object to perform a jump action in a direction away from the predetermined object in response to a first operation input (a specific example is an action operation input) by the user while the player object is running on the predetermined object; and
a third running control unit (step S24, step S54, step S74, step S114) that causes the player object to run in a running state that is advantageous in the race game after the player object lands from the jump action.

The “general area” refers to an area in which the player object can run while changing the moving direction in accordance with a directional operation input by the player. Therefore, the “general area” is not limited to roads in the virtual space, but means to also include the ground beside roads, and water if the player object is an object capable of traveling on water.

The predetermined object refers to a wall object and a rail object in the embodiment described above, but is not limited thereto. For example, in other embodiments, the predetermined object may be a special road object of a race course.

According to the configuration above, the player object can not only run on the predetermined object, but can also run in an advantageous running state under a certain condition when running on the predetermined object. Thus, in the race game, the player will perform game operations while considering whether the player object can run faster by running on the predetermined object or in the general area, for example. Thus, in the exemplary embodiment, whether the player can play the race game advantageously depends on whether or not the player controls the player object to run on the predetermined object in the race game. Therefore, a strategic aspect can be generated by the decision of whether or not to control the player object to run on the predetermined object, thereby improving the strategic aspect of the race game.

“Causing the player object to run in a running state that is advantageous in the race game after the player object lands from the jump action” means that there may or may not be a condition set regarding the position at which the player object lands. That is, the third running control unit may cause the player object to run in an advantageous running state on the condition that the position at which the player object landed from the jump action be a specific position (e.g., a position on a wall object or a rail object), or may cause the player object to run in an advantageous running state, regardless of the landing position.

It should be noted that in the embodiment described above, one example of the third running state and the advantageous running state is a state in which the player object is controlled to run at a faster speed than the speed of the player object in the normal running state (i.e., the turbo state). Then, the player can cause the player object to run faster on the course by setting the player object to the third running state or the advantageous running state. In a state where the player object runs at a faster speed, it may become difficult to turn a sharp corner, for example, and the player is required to perform game operations while considering the timing to set the player object to such a state. This can improve the strategic aspect of the race game.

It should be noted that in other embodiments, the third running state and the advantageous running state are not limited to a state in which the player object can run at a high speed, but can be any state that is advantageous for the player object in the race game. For example, the third running state and the advantageous running state may be a state in which the effects of items used by the player object are enhanced, or the player object can use more items. For example, the third running state and the advantageous running state may be a state in which attacks from other objects are nullified (so-called invincible state), or a state in which the player object can more easily, than normal, bounce off other objects that collide with the player object.

In other embodiments, the advantageous running state following the drift state, like the advantageous running state following the power-charge state, is not limited to a state in which the player object can run at a high speed, but may be any state that is advantageous for the player object in the race game.

While the “race game” is a game in which the mobile object runs from start to goal on a defined course to compete for position and time in the embodiment described above, the race game is not limited to this. For example, the following are also examples of the race game.
A game with an undefined course, where the mobile object can move along any route in the virtual space from start to goal, and even if the player object runs off a road, the player object is not returned to the road or disqualified.
A game in which no other mobile objects other than the player object appear, such as in a time attack in which the time from start to goal is measured for the player object.
A game in which multiple mobile objects compete with each other for a measure other than position or time (e.g., the distance traveled within a predetermined amount of time, or the amount of damage inflicted on other mobile objects, etc.).

### (Variations Regarding Operation Input)

While the embodiment described above is directed to an example case in which the player uses a controller to make operation inputs, the implementation for the player to make operation inputs is arbitrary. In other embodiments, the race game may be executed on an information processing device with a touch panel (e.g., a smartphone), and operation inputs may be made using the touch panel. Then, a directional operation input may be an operation input made by touching the touch panel and then moving the touch position left and right (also called sliding or dragging). An action operation input may be an input that is made by touching the touch panel. It should be noted that the position to be touched may be a predetermined position on the display where the game image is displayed, or it may be an arbitrary position. In such a case, the operation to cancel the drift state or the power-charge state may be an operation of ending the touch input for the action operation input.

It should be noted that an acceleration operation input, a brake operation input, and an item operation input can be made in the exemplary embodiment, in addition to the directional operation input and the action operation input. Here, in other embodiments, these operation inputs may not be accepted, and the control of the player object in response to these operation inputs may be performed automatically by the game system. For example, in other embodiments, the speed of the player object may be controlled automatically.

### (Variations Regarding Special Jump)

In the exemplary embodiment, a special jump is an action with the following features: (a) the player object enters the turbo state after landing, (b) the player object performs an action in response to a directional operation input, (c) the amount of movement in the left-right direction is greater than a normal jump, and (d) the player object can perform a wall run. In other embodiments, the special jump does not need to have all of these features, but may have any one of the features, or may have features different from the above.

It should be noted that in the embodiment described above, where a process is executed using data (which is meant to include programs) on an information processing device, a part of data necessary for the process may be transmitted from another information processing device that is different from the information processing device. In this case, the first information processing device may execute the process using data received from the second information processing device and data stored in the first information processing device.

It should be noted that in other embodiments, the information processing system does not need to include some of the components of the embodiment described above and does not need to execute some of the processes that are executed in the embodiment described above. For example, in order to realize a specific one of the advantageous effects of the embodiment described above, the information processing system may include a component or components for realizing the specific advantageous effect and execute a process or processes for realizing the specific advantageous effect, and the information processing system does not need to include other components and does not need to execute other processes.

The embodiment described above can be used as, for example, a game program or a game system, with the aim of improving the playability of operations performed when an object is running straight in a race game, for example.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

1. One or more non-transitory computer-readable media having stored therein instructions that, when executed, cause one or more processors to execute race game operations comprising:
controlling a player object in a virtual space in accordance with a user operation;
causing the player object to move in a first moving state if there is a first operation input at a time of landing of the player object on a track path and if there is a predetermined turn operation input at a predetermined timing at or before the time of landing;
causing the player object to move in a second moving state different from the first moving state if there is the first operation input at the time of landing of the player object on the track path and if there is not the turn operation input at the predetermined timing; and
causing the player object to temporarily move in a third moving state that is advantageous in a race game based on a parameter that increases in accordance with continuation of the second moving state.

2. The media according to claim 1, wherein a speed of the player object in the third moving state is faster than a speed of the player object in a normal moving state.

3. The media according to claim 1, wherein the second moving state is disadvantageous in the race game.

4. The media according to claim 3, wherein a speed of the player object in the second moving state is slower than a speed of the player object in a normal moving state.

5. The media according to claim 1, wherein a cornering performance of the player object in the second moving state is lower than the cornering performance of the player object in the first moving state.

6. The media according to claim 3, wherein the cornering performance of the player object in the second moving state is lower than the cornering performance of the player object in the normal moving state.

7. The media according to claim 1, wherein causing the player object to temporarily move in the third moving state is executed based on the parameter reaching a predetermined value.

8. The media according to claim 1, wherein the race game operations further comprise causing the player object to perform a first jump action in response to the first operation input being made while the player object is moving on the track path.

9. The media according to claim 1, wherein causing the player object to move in the second moving state is executed if the speed of the player object moving on the track path in a normal moving state exceeds a first speed while the first operation input is continuing.

10. The media according to claim 9, wherein causing the player object to move in the second moving state is executed if there is the first operation input at the time of landing of the player object on the track path, if there is not the turn operation input at the predetermined timing, and if the speed at the time of landing has exceeded a second speed.

11. The media according to claim 1, wherein:
causing the player object to move in the second moving state is executed while the first operation input is continuing since the first operation input was made; and
causing the player object to move in the third moving state is executed in response to ending of the continuing first operation input after the parameter reaches the predetermined value.

12. The media according to claim 11, wherein the race game operations further comprise:
causing the player object to perform a first jump action in response to the first operation input being made while the player object is moving; and
causing the player object moving in the second moving state to perform a second jump action in response to ending of the continuing first operation input after the parameter reaches the predetermined value.

13. The media according to claim 12, wherein causing the player object to move in the third moving state is executed after the player object lands from the second jump action.

14. The media according to claim 12, wherein the second jump action is executed based on the turn operation input made upon ending of the continuing first operation input.

15. The media according to claim 14, wherein the second jump action is executed based on the turn operation input made upon ending of the continuing first operation input, wherein an amount of movement by the second jump action is greater than an amount of movement by the first jump action.

16. The media according to claim 14, wherein the race game operations further comprise causing the player object to move in a fourth moving state, in which the player object is caused to move on a wall surface, in response to the player object coming into proximity with a wall surface while performing the second jump action.

17. The media according to claim 1, wherein the race game operations further comprise causing the player object to temporarily move in a fifth moving state that is advantageous in the race game based on a parameter that increases in accordance with continuation of the first moving state.

18. The media according to claim 17, wherein a speed of the player object in the fifth moving state is faster than the speed of the player object in a normal moving state.

19. The media according to claim 1, wherein the race game operations further comprise displaying the player object on a display device in different manners of display in the first moving state and in the second moving state.

20. The media according to claim 1, wherein:
a plurality of circuit courses and connecting courses that connect between the circuit courses are arranged in the virtual space; and
in the race game, the player object is movable in two or more of the circuit courses and a connecting course that connects together the two or more circuit courses.

21. An information processing system comprising:
a memory and one or more processors configured to execute race game operations comprising:
controlling a player object in a virtual space in accordance with a user operation;
causing the player object to move in a first moving state if there is a first operation input at a time of landing of the player object on a track path and if there is a predetermined turn operation input at a predetermined timing at or before the time of landing;
causing the player object to move in a second moving state different from the first moving state if there is the first operation input at the time of landing of the player object on the track path and if there is not the turn operation input at the predetermined timing; and
causing the player object to temporarily move in a third moving state that is advantageous in the race game based on a parameter that increases in accordance with continuation of the second moving state.

22. A game processing method executable by an information processing system executing a race game, the method comprising:
controlling a player object in a virtual space in accordance with a user operation;
causing the player object to move in a first moving state if there is a first operation input at a time of landing of the player object on a track path and if there is a predetermined turn operation input at a predetermined timing at or before the time of landing;
causing the player object to move in a second moving state different from the first moving state if there is the first operation input at the time of landing of the player object on the track path and if there is not the turn operation input at the predetermined timing; and
causing the player object to temporarily move in a third moving state that is advantageous in the race game based on a parameter that increases in accordance with continuation of the second moving state.
